(19) United States
(12) Patent Application Publication
(10) Pub. No.: US 2024/0129904 A1
(43) Pub. Date: Apr. 18, 2024

(54) TECHNIQUES FOR PERFORMING MEASUREMENTS USING MULTIPLE MEASUREMENT GAP OCCASIONS

(71) Applicant: QUALCOMM Incorporated, San Diego, CA (US)

(72) Inventors: Carlos CABRERA MERCADER, Cardiff, CA (US); Sony AKKARAKARAN, Poway, CA (US); Qunfeng HE, San Diego, CA (US); Arvind Vardarajan SANTHANAM, San Diego, CA (US); Alexandros MANOLAKOS, Escondido, CA (US); Guttorm Ringstad OPSHAUG, Redwood City, CA (US); Sven FISCHER, Nuremberg (DE)

(21) Appl. No.: 18/264,746

(22) PCT Filed: Mar. 10, 2022
(86) PCT No.: PCT/US2022/019789

§ 371 Date: Aug. 8, 2023

(30) Foreign Application Priority Data
Apr. 6, 2021 (GR) 20210100232

(51) Int. Cl. H04W 72/0446; H04L 5/00; H04W 72/23; H04W 72/542

(52) U.S. Cl. CPC H04W 72/0446; H04L 5/0048; H04L 5/0053; H04W 72/23; H04W 72/542

(57) ABSTRACT

Techniques for wireless communication at a communication device are described. The communication device may be a user equipment (UE) configured to transmit, to a base station, signaling indicating UE capability information. The UE may receive, from the base station, control signaling indicating a measurement gap sequence configuration based on the UE capability information. The UE may determine a measurement gap occasion based on the measurement gap sequence configuration. The measurement gap occasion may include one or more of a first measurement gap occasion associated with a first measurement gap sequence, a second measurement gap occasion associated with a second measurement gap sequence, or a combination of the first measurement gap occasion and the second measurement gap occasion. The UE may perform a set of channel measurements during the determined measurement gap occasion.

### CROSS REFERENCE

The present application is a 371 national stage filing of International PCT Application No. PCT/US2022/019789 by CABRERA MERCADER et al. entitled “TECHNIQUES FOR PERFORMING MEASUREMENTS USING MULTIPLE MEASUREMENT GAP OCCASIONS,” filed Mar. 10, 2022; and claims priority to Greece Patent Application No. 20210100232 by CABRERA MERCADER et al., entitled “TECHNIQUES FOR PERFORMING MEASUREMENTS USING MULTIPLE MEASUREMENT GAP OCCASIONS,” filed Apr. 6, 2021, each of which is assigned to the assignee hereof, and each of which is expressly incorporated by reference in its entirety herein.

### FIELD OF DISCLOSURE

The present disclosure, for example, relates to wireless communication systems, more particularly to techniques for performing measurements using multiple measurement gap occasions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

Various aspects of the present disclosure relate to techniques for performing measurements using multiple measurement gap occasions. The use of multiple measurement gap occasions may result in greater flexibility to perform channel measurements associated with different criteria (e.g., timing requirements). A user equipment (UE) may aggregate two or more measurement gap occasions to yield an aggregate measurement gap occasion. This aggregate measurement gap occasion may have a number of measurement interruption durations (e.g., due to radio frequency (RF) retuning and reconfiguration). The measurement interruption durations may be configured at a beginning and at an ending of the aggregate measurement gap occasion. Additionally, the UE may configure one or more additional measurement interruption durations within the aggregate measurement gap occasion as described herein.

A UE may also aggregate two or more measurement gap occasions that are within a duration of each other (e.g., not back-to-back in a time domain) and nonoverlapping to yield an aggregate measurement gap occasion. As such, the duration (e.g., spacing) between the individual measurement gap occasions may be absorbed into the aggregate measurement gap occasion. In other examples, a UE may aggregate two or more measurement gap occasions that are contiguous (e.g., back-to-back in a time domain) and overlapping to yield an aggregate measurement gap occasion as described herein. Other aspects of the present disclosure may enable the UE to cancel one or more measurement gap occasions that are contiguous and overlapping in a time domain, or contiguous and nonoverlapping in a time domain as described herein. The present disclosure may promote higher reliability and lower latency channel measurements, among other benefits by using multiple measurement gap occasions to perform channel measurements associated with different criteria.

A method for wireless communication at a UE is described. The method may include transmitting, to a base station, signaling indicating UE capability information, receiving, from the base station, control signaling indicating a measurement gap sequence configuration based on the UE capability information, determining a measurement gap occasion based on the measurement gap sequence configuration, the measurement gap occasion including one or more of a first measurement gap occasion associated with a first measurement gap sequence, a second measurement gap occasion associated with a second measurement gap sequence, or a combination of the first measurement gap occasion and the second measurement gap occasion, and performing a set of channel measurements during the determined measurement gap occasion.

An apparatus for wireless communication at a UE is described. The apparatus may include a processor, memory coupled with the processor, and instructions stored in the memory. The instructions may be executable by the processor to cause the apparatus to transmit, to a base station, signaling indicating UE capability information, receive, from the base station, control signaling indicating a measurement gap sequence configuration based on the UE capability information, determine a measurement gap occasion based on the measurement gap sequence configuration, the measurement gap occasion including one or more of a first measurement gap occasion associated with a first measurement gap sequence, a second measurement gap occasion associated with a second measurement gap sequence, or a combination of the first measurement gap occasion and the second measurement gap occasion, and perform a set of channel measurements during the determined measurement gap occasion.

Another apparatus for wireless communication at a UE is described. The apparatus may include means for transmitting, to a base station, signaling indicating UE capability information, means for receiving, from the base station, control signaling indicating a measurement gap sequence configuration based on the UE capability information, means for determining a measurement gap occasion based on the measurement gap sequence configuration, the measurement gap occasion including one or more of a first measurement gap occasion associated with a first measurement gap sequence, a second measurement gap occasion associated with a second measurement gap sequence, or a combination of the first measurement gap occasion and the second measurement gap occasion, and means for performing a set of channel measurements during the determined measurement gap occasion.

A non-transitory computer-readable medium storing code for wireless communication at a UE is described. The code may include instructions executable by a processor to transmit, to a base station, signaling indicating UE capability information, receive, from the base station, control signaling indicating a measurement gap sequence configuration based on the UE capability information, determine a measurement gap occasion based on the measurement gap sequence configuration, the measurement gap occasion including one or more of a first measurement gap occasion associated with a first measurement gap sequence, a second measurement gap occasion associated with a second measurement gap sequence, or a combination of the first measurement gap occasion and the second measurement gap occasion, and perform a set of channel measurements during the determined measurement gap occasion.

Some examples of the method, apparatuses, and non-transitory computer-readable medium described herein may further include operations, features, means, or instructions for aggregating a subset of measurement gap occasions based on the measurement gap sequence configuration. In some examples of the method, apparatuses, and non-transitory computer-readable medium described herein, the aggregated subset of measurement gap occasions includes a first measurement interruption duration associated with the first measurement gap occasion and occurring at a beginning of the first measurement gap occasion, a second measurement interruption duration associated with the second measurement gap occasion and occurring at an ending of the second measurement gap occasion, and a measurement gap duration associated with the first measurement gap occasion and the second measurement gap occasion.

In some examples of the method, apparatuses, and non-transitory computer-readable medium described herein, the measurement gap duration may be a combined measurement gap duration including a first measurement gap duration associated with the first measurement gap occasion and a second measurement gap duration associated with the second measurement gap occasion.

Some examples of the method, apparatuses, and non-transitory computer-readable medium described herein may further include operations, features, means, or instructions for assigning a third measurement interruption duration in the measurement gap duration based on the measurement gap sequence configuration, the measurement gap duration may be a combined measurement gap duration including a first measurement gap duration associated with the first measurement gap occasion and a second measurement gap duration associated with the second measurement gap occasion. In some examples of the method, apparatuses, and non-transitory computer-readable medium described herein, the aggregated subset of measurement gap occasions includes the first measurement interruption duration, the second measurement interruption duration, and the third measurement interruption duration.

Some examples of the method, apparatuses, and non-transitory computer-readable medium described herein may further include operations, features, means, or instructions for determining a temporal location for the third measurement interruption duration in the measurement gap duration based on one or more of the first measurement interruption duration, the second measurement interruption duration, or the third measurement interruption duration satisfying a threshold.

In some examples of the method, apparatuses, and non-transitory computer-readable medium described herein, the first measurement gap occasion and the second measurement gap occasion may be one or more of contiguous or overlapping in a time domain.

In some examples of the method, apparatuses, and non-transitory computer-readable medium described herein, the first measurement gap occasion and the second measurement gap occasion may be one or more of noncontiguous or nonoverlapping in a time domain.

Some examples of the method, apparatuses, and non-transitory computer-readable medium described herein may further include operations, features, means, or instructions for determining a duration between the first measurement gap occasion and the second measurement gap occasion, aggregating a subset of measurement gap occasions including the first measurement gap occasion and the second measurement gap occasion based on determining that the duration between the first measurement gap occasion and the second measurement gap occasion satisfies a threshold. In some examples of the method, apparatuses, and non-transitory computer-readable medium described herein, performing the set of channel measurements may be during the aggregated subset of measurement gap occasions.

In some examples of the method, apparatuses, and non-transitory computer-readable medium described herein, a measurement gap duration associated with the aggregated subset of measurement gap occasions includes a first measurement gap duration associated with the first measurement gap occasion, a second measurement gap duration associated with the second measurement gap occasion, and the duration between the first measurement gap occasion and the second measurement gap occasion.

Some examples of the method, apparatuses, and non-transitory computer-readable medium described herein may further include operations, features, means, or instructions for ignoring the first measurement gap occasion or the second measurement gap occasion based on one or more of a criterion or that the duration between the first measurement gap occasion and the second measurement gap occasion satisfies the threshold.

In some examples of the method, apparatuses, and non-transitory computer-readable medium described herein, the criterion includes one or more of the first measurement gap occasion beginning before or after the second measurement gap occasion, a first measurement duration associated with the first measurement gap occasion may be greater or less than a second measurement duration associated with the second measurement gap occasion, a first priority associated with the first measurement gap occasion may be higher or lower than a second priority associated with the second measurement gap occasion, or a first reference signal measurement associated with the first measurement gap occasion and a second reference signal measurement associated with the second measurement gap occasion.

In some examples of the method, apparatuses, and non-transitory computer-readable medium described herein, the criterion includes one or more of a radio resource control (RRC) configuration, an active bandwidth part (BWP), or the UE capability information.

Some examples of the method, apparatuses, and non-transitory computer-readable medium described herein may further include operations, features, means, or instructions for determining an overlap portion between a first portion of the first measurement gap occasion and a second portion of the second measurement gap occasion. In some examples of the method, apparatuses, and non-transitory computer-readable medium described herein, performing the set of channel measurements may be based on the determining of the overlap portion between the first portion of the first measurement gap occasion and the second portion of the second measurement gap occasion.

Some examples of the method, apparatuses, and non-transitory computer-readable medium described herein may further include operations, features, means, or instructions for assigning the overlap portion to the first measurement gap occasion or the second measurement gap occasion based on a criterion. In some examples of the method, apparatuses, and non-transitory computer-readable medium described herein, performing the set of channel measurements may be based on the assigning of the overlap portion to the first measurement gap occasion or the second measurement gap occasion.

In some examples of the method, apparatuses, and non-transitory computer-readable medium described herein, the criterion includes one or more of the first measurement gap occasion beginning before or after the second measurement gap occasion, a first measurement duration associated with the first measurement gap occasion may be greater or less than a second measurement duration associated with the second measurement gap occasion, a first priority associated with the first measurement gap occasion may be higher or lower than a second priority associated with the second measurement gap occasion, or a first reference signal measurement associated with the first measurement gap occasion and a second reference signal measurement associated with the second measurement gap occasion.

In some examples of the method, apparatuses, and non-transitory computer-readable medium described herein, the criterion includes one or more of an RRC configuration, an active BWP, or the UE capability information.

Some examples of the method, apparatuses, and non-transitory computer-readable medium described herein may further include operations, features, means, or instructions for ignoring the first measurement gap occasion or the second measurement gap occasion based on the determining of the overlap portion between the first portion of the first measurement gap occasion and the second portion of the second measurement gap occasion.

Some examples of the method, apparatuses, and non-transitory computer-readable medium described herein may further include operations, features, means, or instructions for aggregating a subset of measurement gap occasions including the first measurement gap occasion and the second measurement gap occasion based on the determining of the overlap portion between the first portion of the first measurement gap occasion and the second portion of the second measurement gap occasion and where performing the set of channel measurements may be in accordance with the aggregated subset of measurement gap occasions.

In some examples of the method, apparatuses, and non-transitory computer-readable medium described herein, a measurement gap duration of the aggregated subset of measurement gap occasions may be based on a first measurement gap duration associated with the first measurement gap occasion, a second measurement gap duration associated with the second measurement gap occasion, and the overlap portion between the first portion of the first measurement gap occasion and the second portion of the second measurement gap occasion, the measurement gap duration including one or more of a first measurement interruption duration associated with the first measurement gap occasion, a second measurement interruption duration associated with the second measurement gap occasion, or a third measurement interruption duration associated with the aggregated subset of measurement gap occasions.

In some examples of the method, apparatuses, and non-transitory computer-readable medium described herein, the control signaling includes radio resource control signaling and the measurement gap sequence configuration indicates one or more of a beginning of the measurement gap occasion or a number of measurement gap occasions associated with a measurement gap sequence including the measurement gap occasion.

A method for wireless communication at a base station is described. The method may include receiving, from a UE, signaling indicating UE capability information, transmitting, to the UE, control signaling indicating a measurement gap sequence configuration based on the UE capability information, and performing a set of reference signal transmissions for a set of channel measurements during a measurement gap occasion associated with the measurement gap sequence configuration, the measurement gap occasion including one or more of a first measurement gap occasion associated with a first measurement gap sequence, a second measurement gap occasion associated with a second measurement gap sequence, or a combination of the first measurement gap occasion and the second measurement gap occasion.

An apparatus for wireless communication at a base station is described. The apparatus may include a processor, memory coupled with the processor, and instructions stored in the memory. The instructions may be executable by the processor to cause the apparatus to receive, from a UE, signaling indicating UE capability information, transmit, to the UE, control signaling indicating a measurement gap sequence configuration based on the UE capability information, and perform a set of reference signal transmissions for a set of channel measurements during a measurement gap occasion associated with the measurement gap sequence configuration, the measurement gap occasion including one or more of a first measurement gap occasion associated with a first measurement gap sequence, a second measurement gap occasion associated with a second measurement gap sequence, or a combination of the first measurement gap occasion and the second measurement gap occasion.

Another apparatus for wireless communication at a base station is described. The apparatus may include means for receiving, from a UE, signaling indicating UE capability information, means for transmitting, to the UE, control signaling indicating a measurement gap sequence configuration based on the UE capability information, and means for performing a set of reference signal transmissions for a set of channel measurements during a measurement gap occasion associated with the measurement gap sequence configuration, the measurement gap occasion including one or more of a first measurement gap occasion associated with a first measurement gap sequence, a second measurement gap occasion associated with a second measurement gap sequence, or a combination of the first measurement gap occasion and the second measurement gap occasion.

A non-transitory computer-readable medium storing code for wireless communication at a base station is described. The code may include instructions executable by a processor to receive, from a UE, signaling indicating UE capability information, transmit, to the UE, control signaling indicating a measurement gap sequence configuration based on the UE capability information, and perform a set of reference signal transmissions for a set of channel measurements during a measurement gap occasion associated with the measurement gap sequence configuration, the measurement gap occasion including one or more of a first measurement gap occasion associated with a first measurement gap sequence, a second measurement gap occasion associated with a second measurement gap sequence, or a combination of the first measurement gap occasion and the second measurement gap occasion.

In some examples of the method, apparatuses, and non-transitory computer-readable medium described herein, the measurement gap occasion includes an aggregated subset of measurement gap occasions including a first measurement interruption duration associated with the first measurement gap occasion, a second measurement interruption duration associated with the second measurement gap occasion, and a measurement gap duration associated with the first measurement gap occasion and the second measurement gap occasion.

In some examples of the method, apparatuses, and non-transitory computer-readable medium described herein, the measurement gap duration includes a first measurement gap duration associated with the first measurement gap occasion and a second measurement gap duration associated with the second measurement gap occasion.

In some examples of the method, apparatuses, and non-transitory computer-readable medium described herein, the aggregated subset of measurement gap occasions includes the first measurement interruption duration, the second measurement interruption duration, and a third measurement interruption duration.

In some examples of the method, apparatuses, and non-transitory computer-readable medium described herein, the first measurement gap occasion and the second measurement gap occasion may be one or more of contiguous or overlapping in a time domain.

In some examples of the method, apparatuses, and non-transitory computer-readable medium described herein, the first measurement gap occasion and the second measurement gap occasion may be noncontiguous or nonoverlapping in a time domain.

In some examples of the method, apparatuses, and non-transitory computer-readable medium described herein, the control signaling includes radio resource control signaling and the measurement gap sequence configuration indicates one or more of a beginning of the measurement gap occasion or a number of measurement gap occasions associated with a measurement gap sequence including the measurement gap occasion.

In some examples of the method, apparatuses, and non-transitory computer-readable medium described herein, the measurement gap duration includes a first measurement gap duration associated with the first measurement gap occasion, a second measurement gap duration associated with the second measurement gap occasion, and a duration between the first measurement gap occasion and the second measurement gap occasion.

### BRIEF DESCRIPTION OF THE DRAWINGS

FIGS. 1 and 2 illustrate examples of wireless communications systems that support techniques for performing measurements using multiple measurement gap occasions in accordance with various aspects of the present disclosure.

FIG. 3 illustrates an example of a measurement gap sequence that supports techniques for performing measurements using multiple measurement gap occasions in accordance with various aspects of the present disclosure.

FIGS. 4 through 15 illustrate examples of measurement gap sequence configurations that support techniques for performing measurements using multiple measurement gap occasions in accordance with various aspects of the present disclosure.

FIG. 16 illustrates an example of a process flow that supports techniques for performing measurements using multiple measurement gap occasions in accordance with various aspects of the present disclosure.

FIGS. 17 and 18 show block diagrams of devices that support techniques for performing measurements using multiple measurement gap occasions in accordance with various aspects of the present disclosure.

FIG. 19 shows a block diagram of a communications manager that supports techniques for performing measurements using multiple measurement gap occasions in accordance with various aspects of the present disclosure.

FIG. 20 shows a diagram of a system including a device that supports techniques for performing measurements using multiple measurement gap occasions in accordance with various aspects of the present disclosure.

FIGS. 21 and 22 show block diagrams of devices that support techniques for performing measurements using multiple measurement gap occasions in accordance with various aspects of the present disclosure.

FIG. 23 shows a block diagram of a communications manager that supports techniques for performing measurements using multiple measurement gap occasions in accordance with various aspects of the present disclosure.

FIG. 24 shows a diagram of a system including a device that supports techniques for performing measurements using multiple measurement gap occasions in accordance with various aspects of the present disclosure.

FIGS. 25 through 29 show flowcharts illustrating methods that support techniques for performing measurements using multiple measurement gap occasions in accordance with various aspects of the present disclosure.

### DETAILED DESCRIPTION

A wireless communications system may include various communication devices, such as a user equipment (UE) and a base station. The wireless communications system, in some examples, may support multiple radio access technologies including fourth generation (4G) systems, such as 4G Long-Term Evolution (LTE), as well as fifth generation (5G) systems, which may be referred to as 5G new radio (NR). In the wireless communications system, a UE may be configured with a measurement gap occasion having a period in which wireless communication between a base station and the UE is temporarily paused. During the measurement gap occasion, the UE may have the opportunity to perform channel measurements of reference signals from the base station or other neighboring communication devices (e.g., other base stations or UEs).

A UE may be enabled to perform a diverse set of channel measurements, where each channel measurement may correspond to different criteria (e.g., timing requirements). For example, some channel measurements may be based on different channel measurement types, channel measurement instances of reference signals, channel measurement periodicities, channel measurement durations, channel measurement frequency location or bandwidth. among other examples. Additionally or alternatively, some channel measurements may have different priorities based on a ranking or an order. As the demand to support greater and more diverse channel measurements, it may be challenging to schedule these channel measurements within a single measurement gap occasion.

To address this challenge, various aspects of the present disclosure relate to enabling a base station and a UE to implement a combined measurement gap occasion via multiple measurement gap occasions. The use of multiple measurement gap occasions may result in greater flexibility to perform the channel measurements associated with different criteria. In some examples, a UE may aggregate two or more measurement gap occasions to yield an aggregate measurement gap occasion. This aggregate measurement gap occasion may have a number of measurement interruption durations (e.g., due to RF retuning and reconfiguration). The measurement interruption durations may be configured at a beginning and at an ending of the aggregate measurement gap occasion. Additionally, a UE may configure one or more additional measurement interruption durations within the aggregate measurement gap occasion as described herein.

In some other examples, a UE may aggregate two or more measurement gap occasions that are within a duration of each other (e.g., not back-to-back in a time domain) and nonoverlapping to yield an aggregate measurement gap occasion. As such, the duration (e.g., spacing) between the individual measurement gap occasions may be absorbed into the aggregate measurement gap occasion. In other examples, a UE may aggregate two or more measurement gap occasions that are contiguous (e.g., back-to-back in a time domain) and overlapping to yield an aggregate measurement gap occasion as described herein. Other aspects of the present disclosure may enable the UE to cancel one or more measurement gap occasions that are contiguous and overlapping in a time domain, or contiguous and nonoverlapping in a time domain as described herein.
Aspects of the subject matter described in the present disclosure may be implemented to realize one or more of the following potential improvements, among others. The techniques employed by the UE may provide benefits and enhancements to the operation of the UE. For example, operations performed by the UE may provide improvements to channel measurements techniques. By using combined channel measurement gap occasions, the UE may experience increased reliability and reduced latency when performing channel measurement operations. Aspects of the disclosure are initially described in the context of wireless communications systems. Aspects of the disclosure are further illustrated by and described with reference to apparatus diagrams, system diagrams, and flowcharts that relate to techniques for performing measurements using multiple measurement gap occasions.

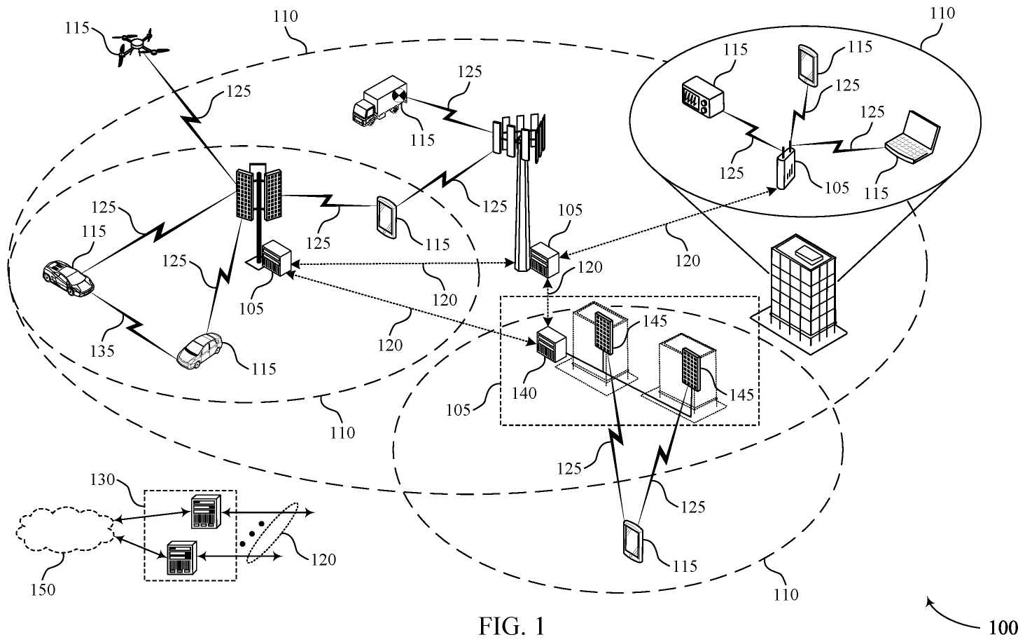

FIG. 1 illustrates an example of a wireless communications system 100 that supports techniques for performing measurements using multiple measurement gap occasions in accordance with various aspects of the present disclosure. The wireless communications system 100 may include one or more base stations 105, one or more UEs 115, and a core network 130. In some examples, the wireless communications system 100 may be an LTE network, an LTE-Advanced (LTE-A) network, an LTE-A Pro network, or a NR network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links. One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples. The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum band resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum band resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f} seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In the wireless communications system 100, a slot may further be divided into multiple mini-slots containing one or more symbols. Excluding the cyclic prefix, each symbol period may contain one or more (e.g., N f) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, in the range of 300 megahertz (MHz) to 300 gigahertz (GHz). The region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), unlicensed radio frequency spectrum band (e.g., LTE-Unlicensed (LTE-U) radio access technology), or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency spectrum band beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with an orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency spectrum band beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In the wireless communications system 100, a UE 115 may be configured to perform channel measurements during one or more measurement gap occasions (also referred to as measurement gaps, measurement gap opportunities, or measurement gap instances). A measurement gap occasion may be a period in which communication between two communication devices in the wireless communications system 100 is temporarily paused. For example, a measurement gap occasion may be a period in which wireless communications between a user-end device (e.g., a UE 115) and a network infrastructure node (e.g., an eNB or a gNB) is temporarily stopped for the purpose of giving at least one of the base station 105 or the UE 115 the opportunity to perform measurements of signals (e.g., reference signals) from other neighboring nodes in the wireless communications system 100. These measurements may be for the purpose of establishing new communication links 125, or for other reasons, such as positioning.

In some cases, one or more measurement gap occasions may be configured by the network (e.g., a base station 105) and may follow a periodic pattern (e.g., a repetitive pattern) also referred to as a measurement gap pattern. These measurement gap patterns may be specified by a combination of a gap pattern identifier, a measurement gap length and measurement gap repetition period (MGRP). In some cases, the wireless communications system 100 may support a single per-UE measurement gap configuration or per-frequency range measurement gap configurations for wireless carriers in each frequency range, such as one for a first frequency range (FR1) and one for a second frequency range (FR2), respectively. However, depending on UE capability some types of measurements might not necessitate measurement gaps.

In the wireless communications system 100, a UE 115 may be enabled to perform a diverse set of channel measurements with different measurement criteria. For example, some measurements may be based on different types or instances of reference signals having different time periodicity, duration, relative timing, frequency location and bandwidth. In some other examples, some measurements may have different priorities based on a ranking or an order. The demand to support a greater diverse set of measurements might be challenging for scheduling all the measurements within a single measurement gap pattern. In some cases, scheduling all the measurements within the single measurement gap pattern may result in the UE 115 experiencing long delays for some measurements. In some other cases, scheduling all the measurements within the single measurement gap pattern may result in the UE 115 not performing some measurements at all, for example, if corresponding reference signals do not overlap in time with configured measurement gaps.

Various aspects of the present disclosure techniques for performing measurements using multiple measurement gap occasions. The use of multiple measurement gap occasions may result in greater flexibility to perform the channel measurements associated with different criteria (e.g., timing requirements). A UE 115 may aggregate two or more measurement gap occasions to yield an aggregate measurement gap occasion. This aggregate measurement gap occasion may have a number of measurement interruption durations (e.g., due to RF retuning and reconfiguration). The measurement interruption durations may be configured at a beginning and at an ending of the aggregate measurement gap occasion. Additionally, a UE 115 may configure one or more additional measurement interruption durations within the aggregate measurement gap occasion as described herein.

A UE 115 may also aggregate two or more measurement gap occasions that are within a duration of each other (e.g., not back-to-back in a time domain) and nonoverlapping to yield an aggregate measurement gap occasion. As such, the duration (e.g., spacing) between the individual measurement gap occasions may be absorbed into the aggregate measurement gap occasion. In other examples, a UE 115 may aggregate two or more measurement gap occasions that are contiguous (e.g., back-to-back in a time domain) and overlapping to yield an aggregate measurement gap occasion as described herein. Other aspects of the present disclosure may enable the UE 115 to cancel one or more measurement gap occasions that are contiguous and overlapping in a time domain, or noncontiguous and nonoverlapping in a time domain as described herein. The wireless communications system 100 may thus promote higher reliability and lower latency channel measurements, among other benefits.

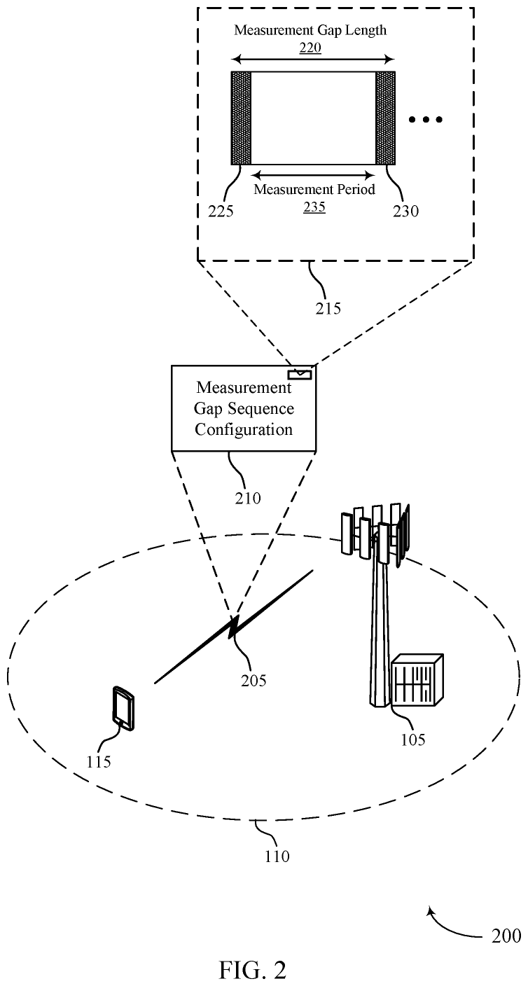

FIG. 2 illustrates an example of a wireless communications system 200 that supports techniques for performing measurements using multiple measurement gap occasions in accordance with various aspects of the present disclosure. In some examples, the wireless communications system 200 may implement aspects of the wireless communications system 100 or may be implemented by aspects of the wireless communications system 100. For example, the wireless communications system 200 may include a base station 105 and a UE 115 within a geographic coverage area 110. The base station 105 and the UE 115 may be examples of corresponding devices described herein with reference to FIG. 1.

The wireless communications system 200 may support multiple radio access technologies including 4G systems such as LTE systems, LTE-A systems, or LTE-A Pro systems, and 5G systems, which may be referred to as NR systems. The wireless communications system 200 may also support improvements to power consumption and, in some examples, may promote enhanced efficiency for higher reliability and lower latency channel measurement operations, among other benefits.

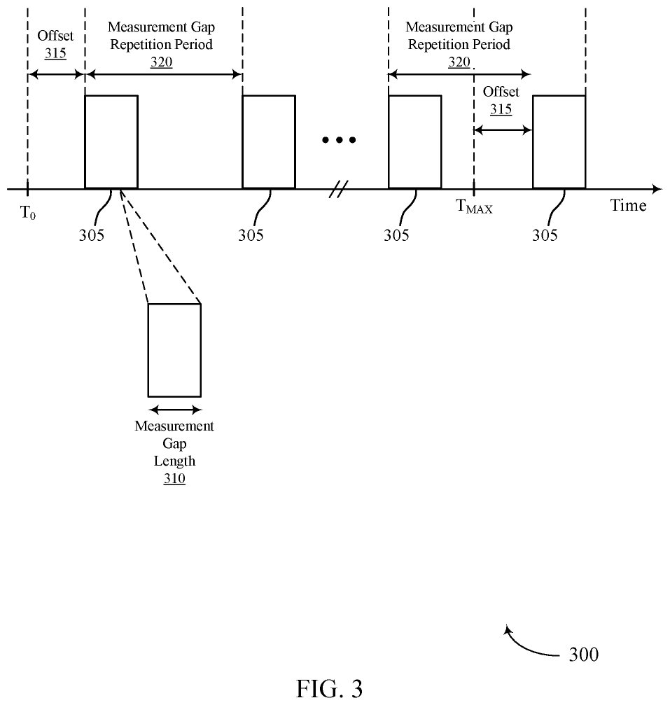

In the example of FIG. 2, the UE 115 may transmit, to the base station 105 over the communication link 205, UE capability information indicating which UE behaviors it supports among those described with reference to FIGS. 3 through 15, respectively. In response, the base station 105 may transmit, to the UE 115 over the communication link 205, control signaling indicating a measurement gap sequence configuration 210 based the UE capability information. The control signaling may be an RRC message and the measurement gap sequence configuration 210 may be indicated via an RRC information element (IE)).

The UE 115 may determine a measurement gap occasion 215 based on the measurement gap sequence configuration 210. The measurement gap occasion 215 may include one or more of a measurement gap length 220, a measurement period 235, a measurement interruption duration 225, and a measurement interruption duration 230. The UE 115 may perform a set of channel measurements during the determined measurement gap occasion 215. For example, the UE 115 may perform measurements of signals (e.g., reference signals) from the base station 105 or other neighboring communication devices. In some examples, the measurement gap occasion 215 may be one or more of a first measurement gap occasion associated with a first measurement gap sequence, a second measurement gap occasion associated with a second measurement gap sequence, or a combination of the first measurement gap occasion and the second measurement gap occasion as described with reference to FIGS. 3 through 15, respectively.

For example, the UE 115 may be enabled to perform a diverse set of channel measurements, where each channel measurement may correspond to different criteria. For example, some channel measurements may be based on different channel measurement types, channel measurement instances of reference signals, channel measurement periodicities, channel measurement durations, channel measurement frequency location or bandwidth, among other examples. Additionally or alternatively, some channel measurements may have different priorities based on a ranking or an order. As the demand to support greater and more diverse channel measurements, it may be challenging to schedule these channel measurements within a single measurement gap occasion.

To address this challenge, the base station 105 and the UE 115 may implement multiple measurement gap occasions for channel measurements. The use of multiple measurement gap occasions may result in greater flexibility to perform the channel measurements associated with different criteria (e.g., timing requirements). In some examples, the UE 115 may aggregate two or more measurement gap occasions to yield an aggregate measurement gap occasion. This aggregate measurement gap occasion may have a number of measurement interruption durations (e.g., due to RF retuning and reconfiguration). The measurement interruption durations may be configured at a beginning and at an ending of the aggregate measurement gap occasion. Additionally, the UE 115 may configure one or more additional measurement interruption durations within the aggregate measurement gap occasion as described herein.

In some other examples, the UE 115 may aggregate two or more measurement gap occasions that are within a duration of each other (e.g., not back-to-back in a time domain) and nonoverlapping to yield an aggregate measurement gap occasion. As such, the duration (e.g., spacing) between the individual measurement gap occasions may be absorbed into the aggregate measurement gap occasion. In other examples, the UE 115 may aggregate two or more measurement gap occasions that are contiguous (e.g., back-to-back in a time domain) and overlapping to yield an aggregate measurement gap occasion as described herein. Other aspects of the present disclosure may enable the UE 115 to cancel one or more measurement gap occasions that are contiguous and overlapping in a time domain, or noncontiguous and nonoverlapping in a time domain as described herein.

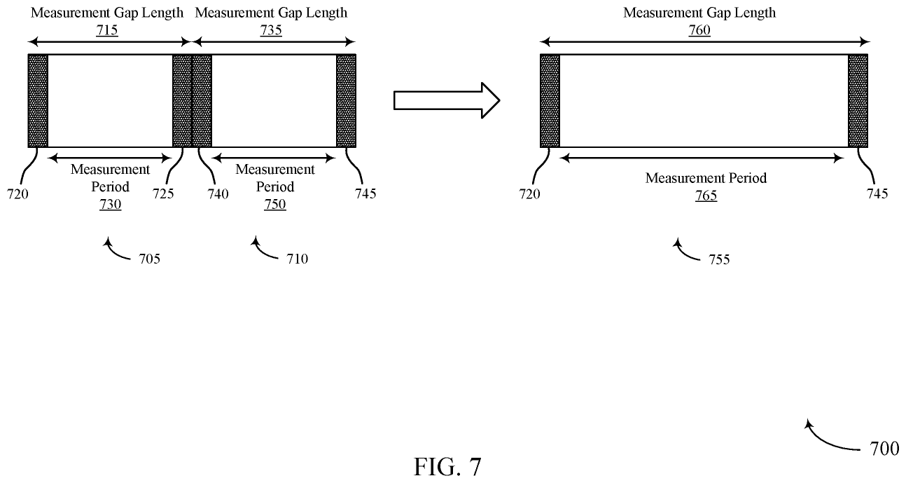

The UE 115 may be able to determine and select between multiple candidate behaviors (e.g., with reference to FIGS. 7 through 15) when more than one behavior is possible according the capabilities of the UE 115 and the measurement gap sequence configuration 210 from the base station 105. In some examples, when such a decision is made by the UE 115, the UE 115 may require signaling back to the base station 105 to maintain coordination (e.g., synchronization) between the base station 105 and the UE 115.

FIG. 3 illustrates an example of a measurement gap sequence 300 that supports techniques for performing measurements using multiple measurement gap occasions in accordance with various aspects of the present disclosure. The measurement gap sequence 300 may implement aspects of the wireless communications system 100 and the wireless communications system 200 or may be implemented by aspects of the wireless communications system 100 and the wireless communications system 200 as described with reference to FIGS. 1 and 2, respectively. For example, the measurement gap sequence 300 may be implemented by a UE 115 to support efficient channel measurements at the UE 115. The measurement gap sequence 300 may further be implemented by a UE 115 to decrease power consumption by providing improvements to channel measurement reliability, among other benefits.

The measurement gap sequence 300 may include one or more measurement gap occasions 305 (also referred to as measurement gap opportunities or measurement gap instances). One or more of the measurement gap occasions 305 as described with reference to FIG. 3 may implement aspects of a measurement gap occasion or may be implemented by aspects of a measurement gap occasion as described with reference to FIGS. 1 and 2, respectively. Each measurement gap occasion 305 may include a measurement gap length 310 (also referred to as a measurement gap duration), in which a UE 115 may perform one or more channel measurements. The measurement gap length 310 may define a duration of each measurement gap occasion 305 associated with the measurement gap sequence 300. During the duration defined by the measurement gap length 310, the UE 115 may perform measurements of signals (e.g., reference signals) from one or more neighboring devices (e.g., neighboring base stations, neighboring UEs). The UE 115 may perform these measurements, for example, for the purpose of establishing a new connection or for other reasons, such as positioning and tracking in a wireless communication system.

In some examples, the measurement gap sequence 300 may have an offset 315, which may be a time offset (e.g., modulo of a measurement gap repetition period 320) of the one or more measurement gap occasions 305 comparative to a timing reference (e.g., To). The timing reference may indicate the time reference (e.g., in the format of a system frame number of a serving cell) with respect to which of the one or more measurement gap occasions 305 are aligned in a time domain. The measurement gap repetition period 320 may define a periodicity of the one or more measurement gap occasions 305. Additionally, the measurement gap sequence 300 may be associated with an activation time (also referred to as a beginning period) for the one or more measurement gap occasions 305. Alternatively or additionally, the measurement gap sequence 300 may be associated with a duration of the measurement gap sequence 300 expressed as a number of measurement gap occasions 305 or another time unit (e.g., To to T_{MAX}).

In some examples, one or more of the above characteristics of the measurement gap sequence 300 may be defined as part of a measurement gap sequence configuration, such as in a MeasGapConfig IE of an RRC configuration. For example, a base station 105 may transmit, to a UE 115, a measurement gap sequence configuration, which may include a set of parameters defining one or more of the above characteristics of the measurement gap sequence 300. One or more of these parameters may include a measurement gap sequence type parameter, which may be per UE and applicable to all serving cells of a base station 105, or per frequency range and applicable to all serving cells of the base station 105 in a respective frequency range. Additionally, these parameters may define the measurement gap length 310, the offset 315, the measurement gap repetition period 320. Additionally or alternatively, these parameters may define the activation time for the one or more measurement gap occasions 305 or the duration of the measurement gap sequence 300.

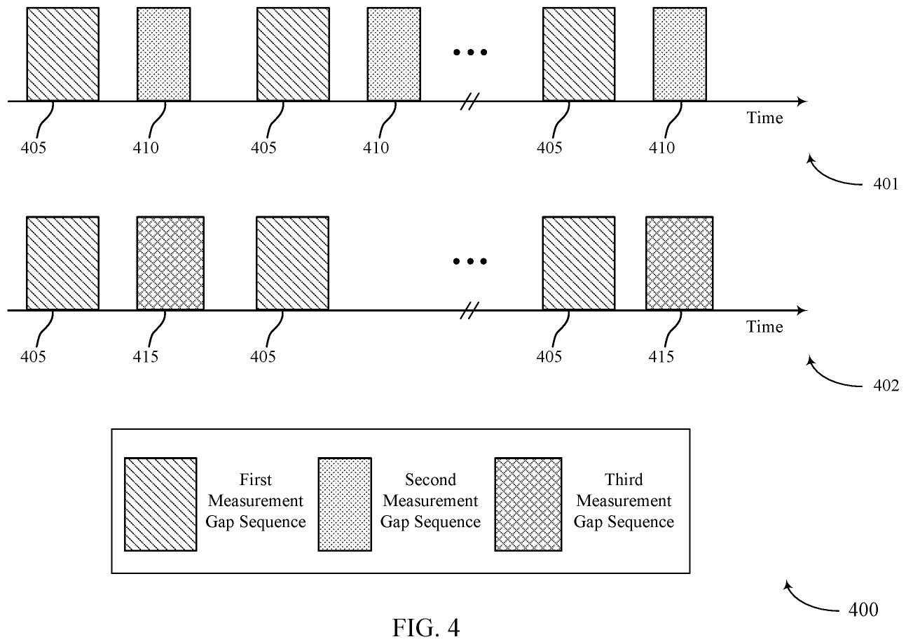

FIG. 4 illustrates an example of a measurement gap sequence configuration 400 that support techniques for performing measurements using multiple measurement gap occasions in accordance with various aspects of the present disclosure. The measurement gap sequence configuration 400 may implement aspects of the wireless communications system 100 and the wireless communications system 200 or may be implemented by aspects of the wireless communications system 100 and the wireless communications system 200 as described with reference to FIGS. 1 and 2, respectively. For example, the measurement gap sequence configuration 400 may be implemented by a UE 115 to support efficient channel measurements at the UE 115. The measurement gap sequence configuration 400 may further be implemented by a UE 115 to decrease power consumption by providing improvements to channel measurement reliability.

The measurement gap sequence configuration 400 may define a nonoverlapping and noncontiguous (e.g., not back-to-back) measurement gap sequence configuration 401. The nonoverlapping and noncontiguous measurement gap sequence configuration 401 may include a first measurement gap sequence having a first set of measurement gap occasions 405, and a second measurement gap sequence having a second set of measurement gap occasions 410. One or more of the measurement gap occasion 405 or the measurement gap occasion 410 as described with reference to FIG. 4 may implement aspects of a measurement gap occasion or may be implemented by aspects of a measurement gap occasion as described with reference to FIGS. 1 and 2, respectively.

In the example of FIG. 4, a respective measurement gap occasion 405 associated with the first measurement gap sequence and a respective measurement gap occasion 410 associated with the second measurement gap sequence might not overlap in a time domain. That is, for the two measurement gap sequences including the first measurement gap sequence and the second measurement gap sequence, the measurement gap occasions 405 do not overlap with the measurement gap occasions 410. Additionally, the measurement gap occasions 405 are nonadjacent (e.g., not back-to-back in a time domain) with the measurement gap occasions 410.

The measurement gap sequence configuration 400 may define a nonoverlapping and noncontiguous (e.g., not back-to-back) measurement gap sequence configuration 402. The nonoverlapping and noncontiguous measurement gap sequence configuration 402 may include a first measurement gap sequence having a first set of measurement gap occasions 405, and a third measurement gap sequence having a second set of measurement gap occasions 415. One or more of the measurement gap occasion 405 or the measurement gap occasion 415 as described with reference to FIG. 4 may implement aspects of a measurement gap occasion or may be implemented by aspects of a measurement gap occasion as described with reference to FIGS. 1 and 2, respectively.

In the example of FIG. 4, a respective measurement gap occasion 405 associated with the first measurement gap sequence and a respective measurement gap occasion 415 associated with the third measurement gap sequence do not overlap in a time domain. That is, for the two measurement gap sequences including the first measurement gap sequence and the third measurement gap sequence, the measurement gap occasions 405 do not overlap with the measurement gap occasions 415. Additionally, the measurement gap occasions 405 are nonadjacent (e.g., not back-to-back) with the measurement gap occasions 415.

The measurement gap sequence configuration 400 thus supports multiple measurement gap sequences (e.g., at least two measurement gap sequences), where the measurement gaps in one measurement gap sequence do not overlap with measurement gaps from another measurement gap sequence, nor are adjacent to measurement gaps from the other measurement gap sequence.

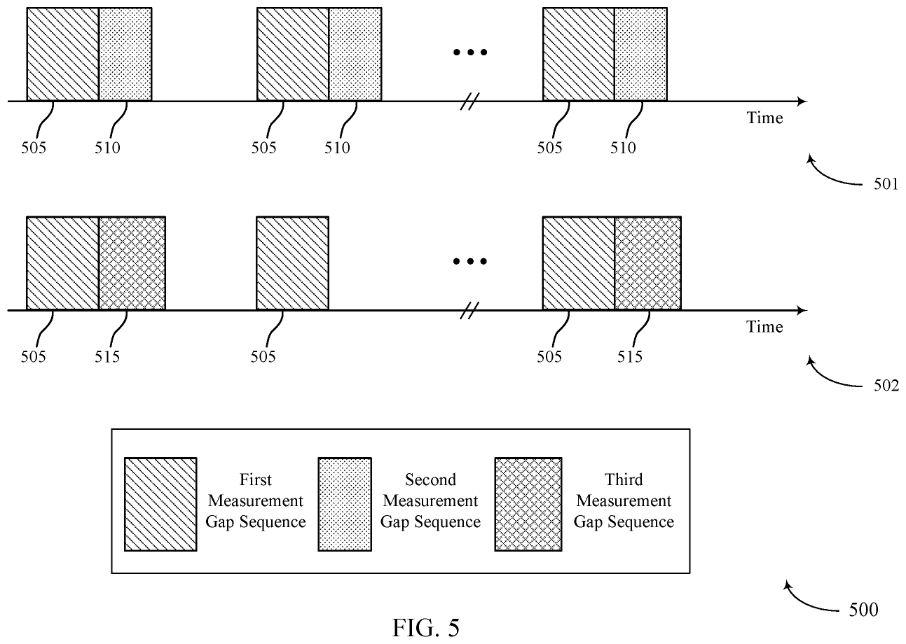

FIG. 5 illustrates an example of a measurement gap sequence configuration 500 that support techniques for performing measurements using multiple measurement gap occasions in accordance with various aspects of the present disclosure. The measurement gap sequence configuration 500 may implement aspects of the wireless communications system 100 and the wireless communications system 200 or may be implemented by aspects of the wireless communications system 100 and the wireless communications system 200 as described with reference to FIGS. 1 and 2, respectively. For example, the measurement gap sequence configuration 500 may be implemented by a UE 115 to support efficient channel measurements at the UE 115. The measurement gap sequence configuration 500 may further be implemented by a UE 115 to decrease power consumption by providing improvements to channel measurement reliability.

The measurement gap sequence configuration 500 may define a nonoverlapping and contiguous (e.g., back-to-back) measurement gap sequence configuration 501. The nonoverlapping and contiguous measurement gap sequence configuration 501 may include a first measurement gap sequence having a first set of measurement gap occasions 505, and a second measurement gap sequence having a second set of measurement gap occasions 510. One or more of the measurement gap occasion 505 or the measurement gap occasion 510 as described with reference to FIG. 5 may implement aspects of a measurement gap occasion or may be implemented by aspects of a measurement gap occasion as described with reference to FIGS. 1 and 2, respectively.

In the example of FIG. 5, a respective measurement gap occasion 505 associated with the first measurement gap sequence and a respective measurement gap occasion 510 associated with the second measurement gap sequence do not overlap in a time domain. That is, for the two measurement gap sequences including the first measurement gap sequence and the second measurement gap sequence, the measurement gap occasions 505 do not overlap with the measurement gap occasions 510. Additionally, the measurement gap occasions 505 are adjacent (e.g., back-to-back) with the measurement gap occasions 510.

The measurement gap sequence configuration 500 may define a nonoverlapping and contiguous (e.g., back-to-back) measurement gap sequence configuration 502. The nonoverlapping and contiguous measurement gap sequence configuration 502 may include a first measurement gap sequence having a first set of measurement gap occasions 505, and a third measurement gap sequence having a second set of measurement gap occasions 515. One or more of the measurement gap occasion 505 or the measurement gap occasion 515 as described with reference to FIG. 5 may implement aspects of a measurement gap occasion or may be implemented by aspects of a measurement gap occasion as described with reference to FIGS. 1 and 2, respectively.

In the example of FIG. 5, a respective measurement gap occasion 505 associated with the first measurement gap sequence and a respective measurement gap occasion 515 associated with the third measurement gap sequence do not overlap in a time domain. That is, for the two measurement gap sequences including the first measurement gap sequence and the third measurement gap sequence, the measurement gap occasions 505 do not overlap with the measurement gap occasions 515. Additionally, the measurement gap occasions 405 are adjacent (e.g., back-to-back) with the measurement gap occasions 515.

The measurement gap sequence configuration 500 thus supports multiple measurement gap sequences (e.g., at least two measurement gap sequences), where the measurement gaps in one measurement gap sequence do not overlap with measurement gaps from another measurement gap sequence, but are adjacent to measurement gaps from the other measurement gap sequence.

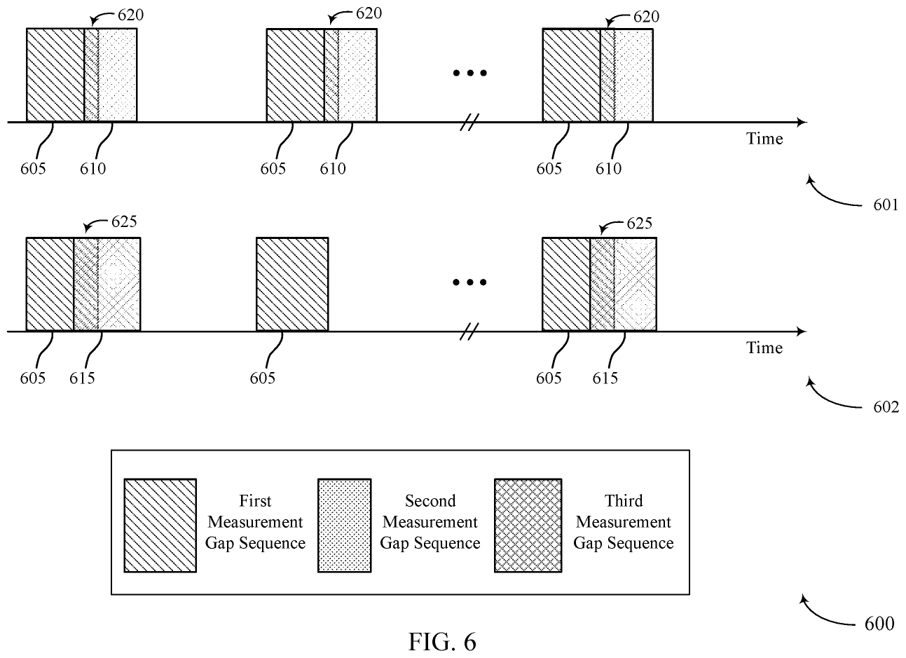

FIG. 6 illustrates an example of a measurement gap sequence configuration 600 that support techniques for performing measurements using multiple measurement gap occasions in accordance with various aspects of the present disclosure. The measurement gap sequence configuration 600 may implement aspects of the wireless communications system 100 and the wireless communications system 200 or may be implemented by aspects of the wireless communications system 100 and the wireless communications system 200 as described with reference to FIGS. 1 and 2, respectively. For example, the measurement gap sequence configuration 600 may be implemented by a UE 115 to support efficient channel measurements at the UE 115. The measurement gap sequence configuration 600 may further be implemented by a UE 115 to experience power saving by providing improvements to channel measurement reliability and latency.

The measurement gap sequence configuration 600 may define an overlapping measurement gap sequence configuration 601. The overlapping measurement gap sequence configuration 601 may include a first measurement gap sequence having a first set of measurement gap occasions 605, and a second measurement gap sequence having a second set of measurement gap occasions 610. In the example of FIG. 6, a respective measurement gap occasion 605 associated with the first measurement gap sequence and a respective measurement gap occasion 610 associated with the second measurement gap sequence may overlap (e.g., partially overlap, or fully overlap) in a time domain. That is, for the two measurement gap sequences including the first measurement gap sequence and the second measurement gap sequence, the measurement gap occasions 605 may include an overlap portion 620 with the measurement gap occasions 610.

The measurement gap sequence configuration 600 may define an overlapping measurement gap sequence configuration 602. The overlapping measurement gap sequence configuration 602 may include a first measurement gap sequence having a first set of measurement gap occasions 605, and a third measurement gap sequence having a second set of measurement gap occasions 615. In the example of FIG. 6, a respective measurement gap occasion 605 associated with the first measurement gap sequence and a respective measurement gap occasion 615 associated with the third measurement gap sequence may overlap (e.g., partially overlap, or fully overlap) in a time domain. That is, for the two measurement gap sequences including the first measurement gap sequence and the third measurement gap sequence, the measurement gap occasions 605 may include an overlap portion 625 with the measurement gap occasions 615.

The measurement gap sequence configuration 600 thus supports multiple measurement gap sequences (e.g., at least two measurement gap sequences), where the measurement gaps in one measurement gap sequence might overlap (e.g., partially overlap, or fully overlap) with measurement gaps from another measurement gap sequence. One or more of the measurement gap occasions as described with reference to FIG. 6 may implement aspects of one or more measurement gap occasions or may be implemented by aspects of one or more measurement gap occasions as described with reference to FIGS. 1 and 2, respectively.

FIG. 7 illustrates an example of a measurement gap sequence configuration 700 that support techniques for performing measurements using multiple measurement gap occasions in accordance with various aspects of the present disclosure. The measurement gap sequence configuration 700 may implement aspects of the wireless communications system 100 and the wireless communications system 200 or may be implemented by aspects of the wireless communications system 100 and the wireless communications system 200 as described with reference to FIGS. 1 and 2, respectively. For example, the measurement gap sequence configuration 700 may be implemented by a UE 115 to support efficient channel measurements at the UE 115. The measurement gap sequence configuration 700 may further be implemented by a UE 115 to experience power saving by providing improvements to channel measurement reliability and latency.

The measurement gap sequence configuration 700 may define a nonoverlapping and contiguous (e.g., in a time domain) measurement gap sequence configuration. The measurement gap sequence configuration 700 may include a first measurement gap occasion 705 associated with a first measurement gap sequence. Additionally, the measurement gap sequence configuration 700 may include a second measurement gap occasion 710 associated with a second measurement gap sequence. One or more of the first measurement gap occasion 705 or the second measurement gap occasion 710 may implement aspects of a measurement gap occasion or may be implemented by aspects of a measurement gap occasion as described with reference to FIGS. 1 and 2, respectively.

The first measurement gap occasion 705 may include a measurement gap length 715 (also referred to as a measurement gap occasion). Additionally, the first measurement gap occasion 705 may include a measurement interruption duration 720 and a measurement interruption duration 725. As such, the first measurement gap occasion 705 may include periods at the beginning and at the ending of the first measurement gap occasion 705 reserved for interruptions due to RF retuning and reconfiguration. The two measurement interruption periods (e.g., the measurement interruption duration 720 and the measurement interruption duration 725) may or may not have the same duration.

In some examples, the actual measurement interruption durations incurred by a UE 115 might be shorter (e.g., no interruption) than the allowed measurement interruption durations. The first measurement gap occasion 705 may also include a measurement period 730 (also referred to as a measurement gap duration), in which a UE 115 may perform measurements of signals (e.g., downlink reference signals, such as demodulation reference signals (DMRS), tracking reference signals (TRS), channel state information reference signals (CSI-RS)) from one or more neighboring devices (e.g., neighboring base stations, neighboring UEs). The UE 115 may perform these measurements, for example, for the purpose of establishing a new communication link, among other examples.

The second measurement gap occasion 710 may be contiguous (e.g., adjacent) in a time domain with the first measurement gap occasion 705. The second measurement gap occasion 710 may include a measurement gap length 735 (also referred to as a measurement gap occasion). Additionally, the second measurement gap occasion 710 may include a measurement interruption duration 740 and a measurement interruption duration 745. Similarly, the second measurement gap occasion 710 may include periods at the beginning and at the ending of the second measurement gap occasion 710 reserved for interruptions due to RF retuning and reconfiguration. The two measurement interruption periods (e.g., the measurement interruption duration 740 and the measurement interruption duration 745) may or may not have the same duration. In some examples, the actual measurement interruption durations incurred by a UE 115 might be shorter (e.g., no interruption) than the allowed measurement interruption durations. The second measurement gap occasion 710 may also include a measurement period 750 (also referred to as a measurement gap duration), in which a UE 115 may perform measurements of signals (e.g., DMRS, TRS, CSI-RS) from one or more neighboring devices (e.g., neighboring base stations, neighboring UEs) as described herein.

In the example of FIG. 7, a UE 115 may be configured to aggregate the first measurement gap occasion 705 and the second measurement gap occasion 710 to yield a combined measurement gap occasion 755 (also referred to as an aggregated measurement gap occasion). The combined measurement gap occasion 755 may include a measurement gap length 760, which may be a combination of the measurement gap length 715 associated with the first measurement gap occasion 705 and the measurement gap length 735 associated with the second measurement gap occasion 710. In the example of FIG. 7, the combined measurement gap occasion 755 may also include periods at the beginning and at the ending of the combined measurement gap occasion 755 reserved for interruptions due to RF retuning and reconfiguration. For example, the combined measurement gap occasion 755 may include the measurement interruption duration 720 and the measurement interruption duration 745. That is, the combined measurement gap occasion 755 may include the beginning measurement interruption duration 720 associated with the first measurement gap occasion 705 and the ending measurement interruption duration 745 associated with the second measurement gap occasion 710.

A UE 115 may thus be configured to combine a number of contiguous measurement gap instances to provide a single extended measurement gap instance with an aggregate length dependent on each of the measurement gap instances (e.g., a first measurement gap length+a second measurement gap length+ . . . +n measurement gap length, wherein n is an integer). The extended measurement gap instance may also be configured to manage RF interruptions and reconfigurations at the beginning of the first measurement gap instance and at the ending of the last measurement gap instance. The extended measurement gap instance thus effectively allows for a longer contiguous measurement period at the UE 115.

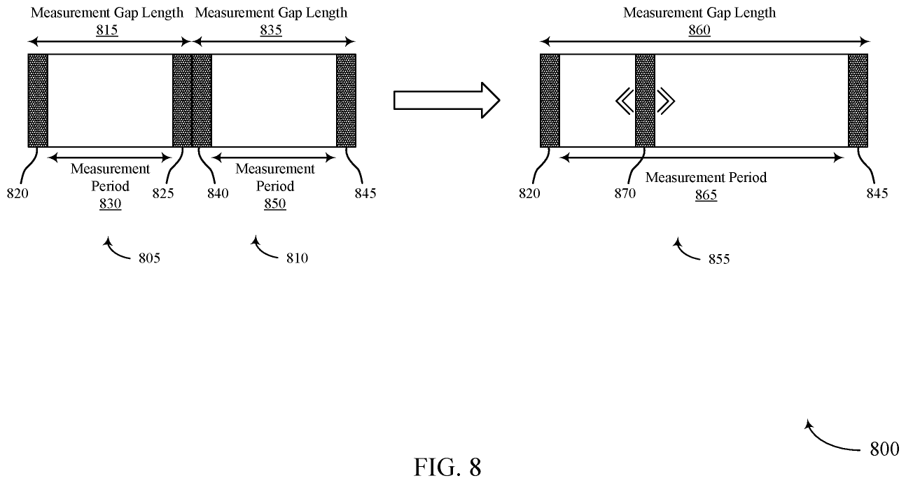

FIG. 8 illustrates an example of a measurement gap sequence configuration 800 that support techniques for performing measurements using multiple measurement gap occasions in accordance with various aspects of the present disclosure. The measurement gap sequence configuration 800 may implement aspects of the wireless communications system 100 and the wireless communications system 200 or may be implemented by aspects of the wireless communications system 100 and the wireless communications system 200 as described with reference to FIGS. 1 and 2, respectively. For example, the measurement gap sequence configuration 800 may be implemented by a UE 115 to support efficient channel measurements at the UE 115. The measurement gap sequence configuration 800 may further be implemented by a UE 115 to experience power saving by providing improvements to channel measurement reliability and latency.

The measurement gap sequence configuration 800 may define a nonoverlapping and contiguous (e.g., in a time domain) measurement gap sequence configuration. The measurement gap sequence configuration 800 may include a first measurement gap occasion 805 associated with a first measurement gap sequence. Additionally, the measurement gap sequence configuration 800 may include a second measurement gap occasion 810 associated with a second measurement gap sequence. One or more of the first measurement gap occasion 805 or the second measurement gap occasion 810 may implement aspects of a measurement gap occasion or may be implemented by aspects of a measurement gap occasion as described with reference to FIGS. 1 and 2, respectively.

The first measurement gap occasion 805 may include a measurement gap length 815 (also referred to as a measurement gap occasion). Additionally, the first measurement gap occasion 805 may include a measurement interruption duration 820 and a measurement interruption duration 825. As such, the first measurement gap occasion 805 may include periods at the beginning and at the ending of the first measurement gap occasion 805 reserved for interruptions due to RF retuning and reconfiguration. The two measurement interruption periods (e.g., the measurement interruption duration 820 and the measurement interruption duration 825) may or may not have the same duration. The first measurement gap occasion 805 may also include a measurement period 830 (also referred to as a measurement gap duration), in which a UE 115 may perform measurements of signals (e.g., reference signals) from one or more neighboring devices (e.g., neighboring base stations, neighboring UEs).

The second measurement gap occasion 810 may be contiguous in a time domain with the first measurement gap occasion 805 (e.g., next to the first measurement gap occasion 805). The second measurement gap occasion 810 may include a measurement gap length 835 (also referred to as a measurement gap occasion). Additionally, the second measurement gap occasion 810 may include a measurement interruption duration 840 and a measurement interruption duration 845. The second measurement gap occasion 810 may include periods at the beginning and at the ending of the second measurement gap occasion 810 reserved for interruptions due to RF retuning and reconfiguration. The two measurement interruption periods (e.g., the measurement interruption duration 840 and the measurement interruption duration 845) may or may not have the same duration. The second measurement gap occasion 810 may also include a measurement period 850 (also referred to as a measurement gap duration), in which a UE 115 may perform measurements of signals (e.g., DMRS, TRS, CSI-RS) from one or more neighboring devices (e.g., neighboring base stations, neighboring UEs) as described herein.

In the example of FIG. 8, a UE 115 may be configured to aggregate the first measurement gap occasion 805 and the second measurement gap occasion 810 to provide a combined measurement gap occasion 855 (also referred to as an aggregated measurement gap occasion). The combined measurement gap occasion 855 may include a measurement gap length 860, which may be a combination of the measurement gap length 815 associated with the first measurement gap occasion 805 and the measurement gap length 835 associated with the second measurement gap occasion 810.

In the example of FIG. 8, the combined measurement gap occasion 855 may also include periods at the beginning and at the ending of the combined measurement gap occasion 755 reserved for interruptions due to RF retuning and reconfiguration. For example, the combined measurement gap occasion 855 may include the measurement interruption duration 820 and the measurement interruption duration 845. That is, the combined measurement gap occasion 855 may include the beginning measurement interruption duration 820 associated with the first measurement gap occasion 805 and the ending measurement interruption duration 845 associated with the second measurement gap occasion 810. Additionally, in the example of FIG. 8, the combined measurement gap occasion 855 may include one or more extra measurement interruption durations, such as the measurement interruption duration 870. A location of the one or more extra measurement interruption durations, such as the measurement interruption duration 870 may be flexible and dependent on a condition that the measurement time equals a fraction of the aggregate measurement gap length 860.

A UE 115 may thus be configured to aggregate a number of contiguous (e.g., back-to-back) measurement gap occasions into a single extended measurement gap occasions with an aggregate length dependent on each of the measurement gap occasions. The extended measurement gap occasions may also be configured to manage RF interruptions and reconfigurations at the beginning of the first measurement gap occasion, at the ending of the last measurement gap occasion, as well as one or more additional RF interruptions in the extended measurement gap occasion. The extended measurement gap occasion thus effectively allows for a longer contiguous measurement period at the UE 115. Additionally, the one or more additional RF interruptions and reconfigurations within the extended measurement gap occasion allow a UE 115 multiple measurements opportunities for different frequency allocations (including BWP, component carrier, frequency layer, a positioning frequency layer (PFL), reference signal) to be performed within the extended measurement gap occasion.

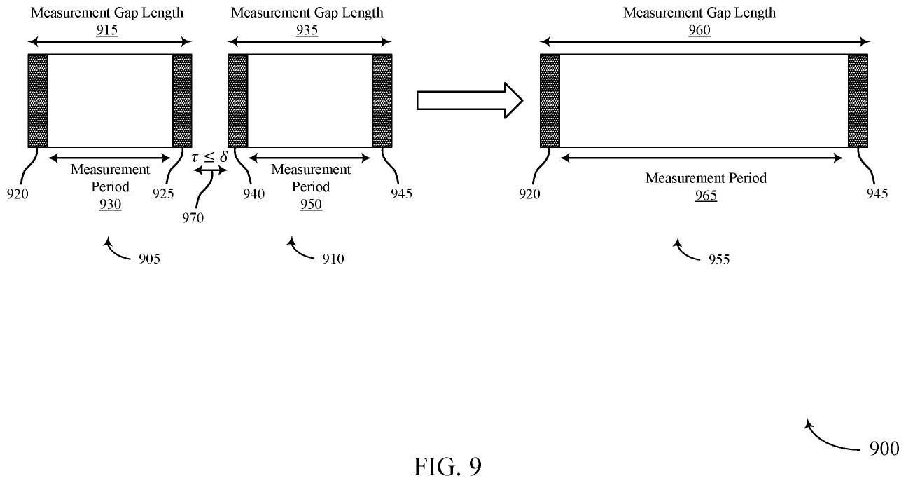

FIG. 9 illustrates an example of a measurement gap sequence configuration 900 that support techniques for performing measurements using multiple measurement gap occasions in accordance with various aspects of the present disclosure. The measurement gap sequence configuration 900 may implement aspects of the wireless communications system 100 and the wireless communications system 200 or may be implemented by aspects of the wireless communications system 100 and the wireless communications system 200 as described with reference to FIGS. 1 and 2, respectively. For example, the measurement gap sequence configuration 900 may be implemented by a UE 115 to support efficient channel measurements at the UE 115. The measurement gap sequence configuration 900 may further be implemented by a UE 115 to experience power saving by providing improvements to channel measurement reliability and latency.

The measurement gap sequence configuration 900 may define a nonoverlapping measurement gap sequence configuration. The measurement gap sequence configuration 900 may include a first measurement gap occasion 905 associated with a first measurement gap sequence. Additionally, the measurement gap sequence configuration 900 may include a second measurement gap occasion 810 associated with a second measurement gap sequence. One or more of the first measurement gap occasion 905 or the second measurement gap occasion 910 may implement aspects of a measurement gap occasion or may be implemented by aspects of a measurement gap occasion as described with reference to FIGS. 1 and 2, respectively.

The first measurement gap occasion 905 may include a measurement gap length 915 (also referred to as a measurement gap occasion). Additionally, the first measurement gap occasion 905 may include a measurement interruption duration 920 and a measurement interruption duration 925. As such, the first measurement gap occasion 905 may include periods at the beginning and at the ending of the first measurement gap occasion 905 reserved for interruptions due to RF retuning and reconfiguration. The two measurement interruption periods (e.g., the measurement interruption duration 920 and the measurement interruption duration 925) may or may not have the same duration. The first measurement gap occasion 905 may also include a measurement period 930 (also referred to as a measurement gap duration), in which a UE 115 may perform measurements of signals (e.g., reference signals) from one or more neighboring devices (e.g., base stations).

The second measurement gap occasion 910 may include a measurement gap length 935 (also referred to as a measurement gap occasion). Additionally, the second measurement gap occasion 910 may include a measurement interruption duration 940 and a measurement interruption duration 945. The second measurement gap occasion 910 may include periods at the beginning and at the ending of the second measurement gap occasion 910 reserved for interruptions due to RF retuning and reconfiguration. The two measurement interruption periods (e.g., the measurement interruption duration 940 and the measurement interruption duration 945) may or may not have the same duration. The second measurement gap occasion 910 may also include a measurement period 950 (also referred to as a measurement gap duration), in which a UE 115 may perform measurements of signals (e.g., reference signals) from one or more neighboring devices (e.g., neighboring base stations) as described herein.

In the example of FIG. 9, the first measurement gap occasion 905 may be within a duration δ 970 from the second measurement gap occasion 910. The first measurement gap occasion 905 and the second measurement gap occasion 910 may be within δ time units of each other, where δ may be a positive value. Additionally, the first measurement gap occasion 905 and the second measurement gap occasion 910 may not be contiguous in a time domain (e.g., not back-to-back) for some duration (e.g., δ value).

A UE 115 may be configured to aggregate the first measurement gap occasion 905 and the second measurement gap occasion 910 to provide a combined measurement gap occasion 955 (also referred to as an aggregated measurement gap occasion). The combined measurement gap occasion 955 may include a measurement gap length 960, which may be a combination of the measurement gap length 915 associated with the first measurement gap occasion 905 and the measurement gap length 935 associated with the second measurement gap occasion 910. In the example of FIG. 9, the combined measurement gap occasion 955 may absorb the duration δ 970 between the first measurement gap occasion 905 and the second measurement gap occasion 910. That is, the space between the individual measurement gap occasions may absorbed into the aggregate measurement gap occasion.

The combined measurement gap occasion 955 may also include periods at the beginning and at the ending of the combined measurement gap occasion 955 reserved for interruptions due to RF retuning and reconfiguration. For example, the combined measurement gap occasion 955 may include the measurement interruption duration 920 and the measurement interruption duration 945. That is, the combined measurement gap occasion 955 may include the beginning measurement interruption duration 920 associated with the first measurement gap occasion 905 and the ending measurement interruption duration 945 associated with the second measurement gap occasion 910.

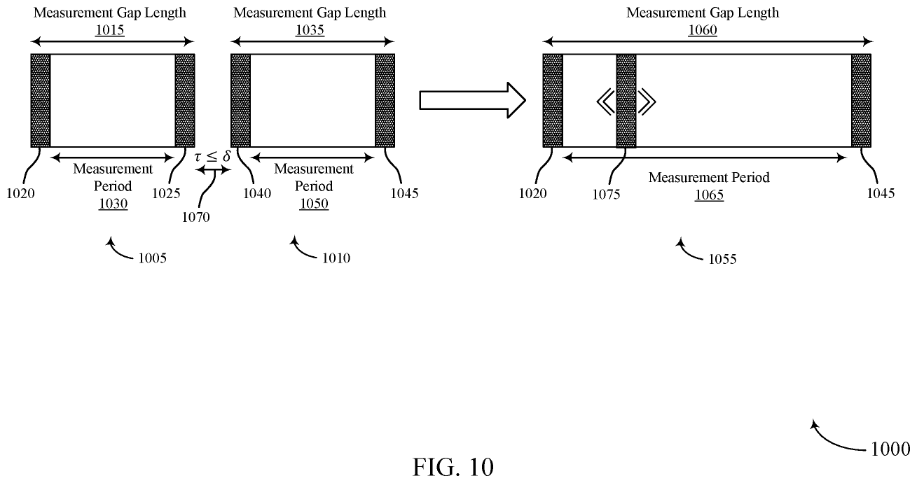

FIG. 10 illustrates an example of a measurement gap sequence configuration 1000 that support techniques for performing measurements using multiple measurement gap occasions in accordance with various aspects of the present disclosure. The measurement gap sequence configuration 1000 may implement aspects of the wireless communications system 100 and the wireless communications system 200 or may be implemented by aspects of the wireless communications system 100 and the wireless communications system 200 as described with reference to FIGS. 1 and 2, respectively. For example, the measurement gap sequence configuration 1000 may be implemented by a UE 115 to support efficient channel measurements at the UE 115. The measurement gap sequence configuration 1000 may further be implemented by a UE 115 to experience power saving by providing improvements to channel measurement reliability and latency.

The measurement gap sequence configuration 1000 may define a nonoverlapping measurement gap sequence configuration. The measurement gap sequence configuration 1000 may include a first measurement gap occasion 1005 associated with a first measurement gap sequence, as well as a second measurement gap occasion 1010 associated with a second measurement gap sequence. One or more of the first measurement gap occasion 1005 or the second measurement gap occasion 1010 may implement aspects of a measurement gap occasion or may be implemented by aspects of a measurement gap occasion as described with reference to FIGS. 1 and 2, respectively.

The first measurement gap occasion 1005 may include a measurement gap length 1015 (also referred to as a measurement gap occasion). Additionally, the first measurement gap occasion 1005 may include a measurement interruption duration 1020 and a measurement interruption duration 1025. The first measurement gap occasion 1005 may include reserved periods at the beginning and at the ending of the first measurement gap occasion 1005 for interruptions due to RF retuning and reconfiguration. The first measurement gap occasion 1005 may include a measurement period 1030 (also referred to as a measurement gap duration), in which a UE 115 may perform measurements of signals (e.g., reference signals) from one or more neighboring devices (e.g., base stations) in a wireless communications system as described with reference to FIGS. 1 and 2, respectively.

The second measurement gap occasion 1010 may include a measurement gap length 1035 (also referred to as a measurement gap occasion). Additionally, the second measurement gap occasion 1010 may include a measurement interruption duration 1040 and a measurement interruption duration 1045. The second measurement gap occasion 1010 may also include reserved periods at the beginning and at the ending of the second measurement gap occasion 1010 for interruptions due to RF retuning and reconfiguration. The second measurement gap occasion 1010 may include a measurement period 1050 (also referred to as a measurement gap duration), in which a UE 115 may perform measurements of signals (e.g., reference signals) from one or more neighboring devices (e.g., neighboring base stations) as described herein.

In the example of FIG. 10, the first measurement gap occasion 1005 may be within a duration δ 1070 from the second measurement gap occasion 1010. The first measurement gap occasion 1005 and the second measurement gap occasion 1010 may be within delta time units of each other. Additionally, the first measurement gap occasion 1005 and the second measurement gap occasion 1010 may not be contiguous in a time domain (e.g., not back-to-back) for some duration (e.g., δ value).

A UE 115 may be configured to aggregate the first measurement gap occasion 1005 and the second measurement gap occasion 1010 to provide a combined measurement gap occasion 1055 (also referred to as an aggregated measurement gap occasion). The combined measurement gap occasion 1055 may include a measurement gap length 1060, which may be a combination of the measurement gap length 1015 associated with the first measurement gap occasion 1005 and the measurement gap length 1035 associated with the second measurement gap occasion 1010. In the example of FIG. 10, the combined measurement gap occasion 1055 may absorb the duration δ 1070 between the first measurement gap occasion 1005 and the second measurement gap occasion 1010.

The combined measurement gap occasion 1055 may also include periods at the beginning and at the ending of the combined measurement gap occasion 1055 reserved for interruptions due to RF retuning and reconfiguration. For example, the combined measurement gap occasion 1055 may include the measurement interruption duration 1020 and the measurement interruption duration 1045. That is, the combined measurement gap occasion 1055 may include the beginning measurement interruption duration 1020 associated with the first measurement gap occasion 1005 and the ending measurement interruption duration 1045 associated with the second measurement gap occasion 1010. In the example of FIG. 10, the combined measurement gap occasion 1055 may also include one or more additional measurement interruption duration, such as the measurement interruption duration 1075. A temporal location of the one or more extra measurement interruption durations, such as the measurement interruption duration 1075 may be variable and dependent on a condition that the measurement time equals a fraction of the aggregate measurement gap length 1060.

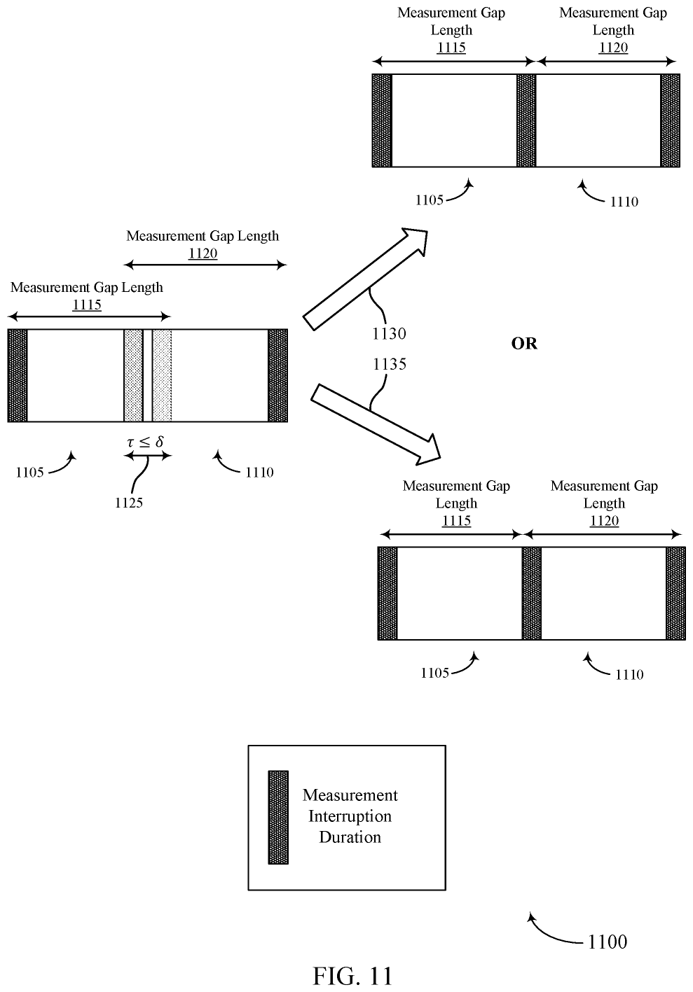

FIG. 11 illustrates an example of a measurement gap sequence configuration 1100 that support techniques for performing measurements using multiple measurement gap occasions in accordance with various aspects of the present disclosure. The measurement gap sequence configuration 1100 may implement aspects of the wireless communications system 100 and the wireless communications system 200 or may be implemented by aspects of the wireless communications system 100 and the wireless communications system 200 as described with reference to FIGS. 1 and 2, respectively. For example, the measurement gap sequence configuration 1100 may be implemented by a UE 115 to support efficient channel measurements at the UE 115. The measurement gap sequence configuration 1100 may further be implemented by a UE 115 to experience power saving by providing improvements to channel measurement reliability and latency.

The measurement gap sequence configuration 1100 may define an overlapping measurement gap sequence configuration. The measurement gap sequence configuration 1100 may include a first measurement gap occasion 1105 associated with a first measurement gap sequence, as well as a second measurement gap occasion 1110 associated with a second measurement gap sequence. One or more of the first measurement gap occasion 1105 or the second measurement gap occasion 1110 may implement aspects of a measurement gap occasion or may be implemented by aspects of a measurement gap occasion as described with reference to FIGS. 1 and 2, respectively.

The first measurement gap occasion 1105 may include a measurement gap length 1115 (also referred to as a measurement gap occasion). Additionally, the first measurement gap occasion 1105 may include at least two measurement interruption durations and measurement period as described with reference to FIGS. 1 through 10, respectively. The second measurement gap occasion 1110 may include a measurement gap length 1120 (also referred to as a measurement gap occasion). Similarly, the second measurement gap occasion 1110 may include at least two measurement interruption durations and measurement period as described with reference to FIGS. 1 through 10, respectively.

In the example of FIG. 11, a portion of the first measurement gap occasion 1105 may overlap with a portion of the second measurement gap occasion 1110. For example, a UE 115 may determine an overlap portion 1125 (e.g., 6) between a portion of the first measurement gap occasion 1105 may overlap with a portion of the second measurement gap occasion 1110. A UE 115 may be configured to assign the overlap portion 1125 to the first measurement gap occasion 1105 or the second measurement gap occasion 1110. In other words, an overlapping portion between two measurement gap occasions may be handled as belonging to one of the two measurement gap occasions and not the other. As a result, one of the measurement gap occasions would be shortened in a time domain.

The UE 115 may be configured to assign the overlap portion 1125 to the first measurement gap occasion 1105 at 1130, or the second measurement gap occasion 1110 at 1135, based on a criterion or a criteria. One or more of the criterion or the criteria may include a measurement gap occasion having an earlier or a later start time, a longest or shortest measurement gap occasion, a priority of a measurement gap occasion or a measurement gap sequence, or reference signal measurements associated with a measurement gap occasion or measurement gap sequence, or a combination thereof. For example, the UE 115 may be configured to assign the overlap portion 1125 to the first measurement gap occasion 1105 or the second measurement gap occasion 1110 based at least in part on whether the first measurement gap occasion 1105 begins before of after the second measurement gap occasion 1110.

In some examples, the UE 115 may be configured to assign the overlap portion 1125 to the first measurement gap occasion 1105 or the second measurement gap occasion 1110 based at least in part on whether the first measurement gap occasion 1105 is longer or shorter in duration than the second measurement gap occasion 1110. In some other examples, the UE 115 may be configured to assign the overlap portion 1125 to the first measurement gap occasion 1105 or the second measurement gap occasion 1110 based at least in part on whether the first measurement gap occasion 1105 has a higher priority or a lower priority than the second measurement gap occasion 1110. In other examples, the UE 115 may be configured to assign the overlap portion 1125 to the first measurement gap occasion 1105 or the second measurement gap occasion 1110 based at least in part on reference signal measurements associated with the first measurement gap occasion 1105 compared to reference signal measurements associated with the second measurement gap occasion 1110.

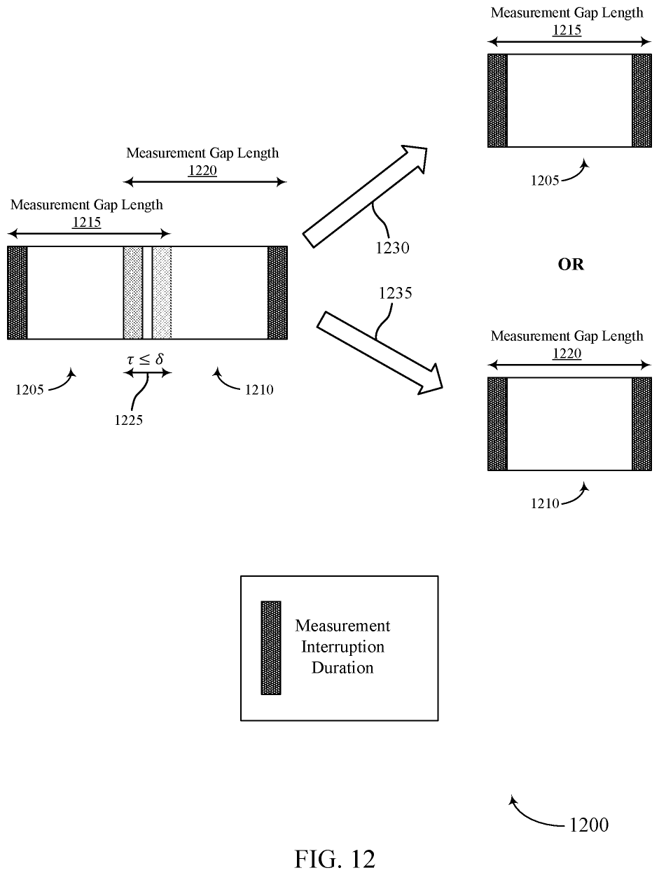

FIG. 12 illustrates an example of a measurement gap sequence configuration 1200 that support techniques for performing measurements using multiple measurement gap occasions in accordance with various aspects of the present disclosure. The measurement gap sequence configuration 1200 may implement aspects of the wireless communications system 100 and the wireless communications system 200 or may be implemented by aspects of the wireless communications system 100 and the wireless communications system 200 as described with reference to FIGS. 1 and 2, respectively. For example, the measurement gap sequence configuration 1200 may be implemented by a UE 115 to support efficient channel measurements at the UE 115. The measurement gap sequence configuration 1200 may further be implemented by a UE 115 to experience power saving by providing improvements to channel measurement reliability and latency.

The measurement gap sequence configuration 1200 may define an overlapping measurement gap sequence configuration. The measurement gap sequence configuration 1200 may include a first measurement gap occasion 1205 associated with a first measurement gap sequence, as well as a second measurement gap occasion 1210 associated with a second measurement gap sequence. One or more of the first measurement gap occasion 1205 or the second measurement gap occasion 1210 may implement aspects of a measurement gap occasion or may be implemented by aspects of a measurement gap occasion as described with reference to FIGS. 1 and 2, respectively.

The first measurement gap occasion 1205 may include a measurement gap length 1215 (also referred to as a measurement gap occasion). Additionally, the first measurement gap occasion 1205 may include at least two measurement interruption durations and measurement period as described with reference to FIGS. 1 through 10, respectively. The second measurement gap occasion 1210 may include a measurement gap length 1220 (also referred to as a measurement gap occasion). Similarly, the second measurement gap occasion 1210 may include at least two measurement interruption durations and measurement period as described with reference to FIGS. 1 through 10, respectively.

In the example of FIG. 12, a portion of the first measurement gap occasion 1205 may overlap with a portion of the second measurement gap occasion 1210. For example, a UE 115 may determine an overlap portion 1225 (e.g., 6) between a portion of the first measurement gap occasion 1205 may overlap with a portion of the second measurement gap occasion 1210. Based on the determination of the overlap portion 1125, a UE 115 may be configured to ignore the first measurement gap occasion 1205 or the second measurement gap occasion 1210. In other words, when two measurement gap occasions overlap, one of them might cancel the other. As such, only one measurement gap occasion gap may be used by the UE 115 for channel measurements. The canceling of a measurement gap occasion may enable (e.g., require) coordination between the UE 115 and the network (e.g., a base station 105), so that the UE 115 and the network are in sync (e.g., know where the measurement gap occasions occur). The UE 115 may be configured to ignore (e.g., cancel) the first measurement gap occasion 1205 at 1230, or the second measurement gap occasion 1210 at 1235, based on a criterion or a criteria. One or more of the criterion or the criteria may include a measurement gap occasion having an earlier or a later start time, a longest or shortest measurement gap occasion, a priority of a measurement gap occasion or a measurement gap sequence, or reference signal measurements associated with a measurement gap occasion or measurement gap sequence, or a combination thereof.

Additionally, the UE 115 may be configured to ignore (e.g., cancel) the first measurement gap occasion 1205 at 1230, or the second measurement gap occasion 1210 at 1235, based on an amount of overlap between the first measurement gap occasion 1205 and the second measurement gap occasion 1210. For example, the UE 115 may be configured to ignore (e.g., cancel) the first measurement gap occasion 1205 if there is more overlap (e.g., above a threshold) at the first measurement gap occasion 1205 compared to the second measurement gap occasion 1210. Otherwise, the UE 115 may be configured to ignore (e.g., cancel) the second measurement gap occasion 1210 at 1235 when there is more overlap (e.g., above a threshold) at the second measurement gap occasion 1210 compared to the first measurement gap occasion 1205.

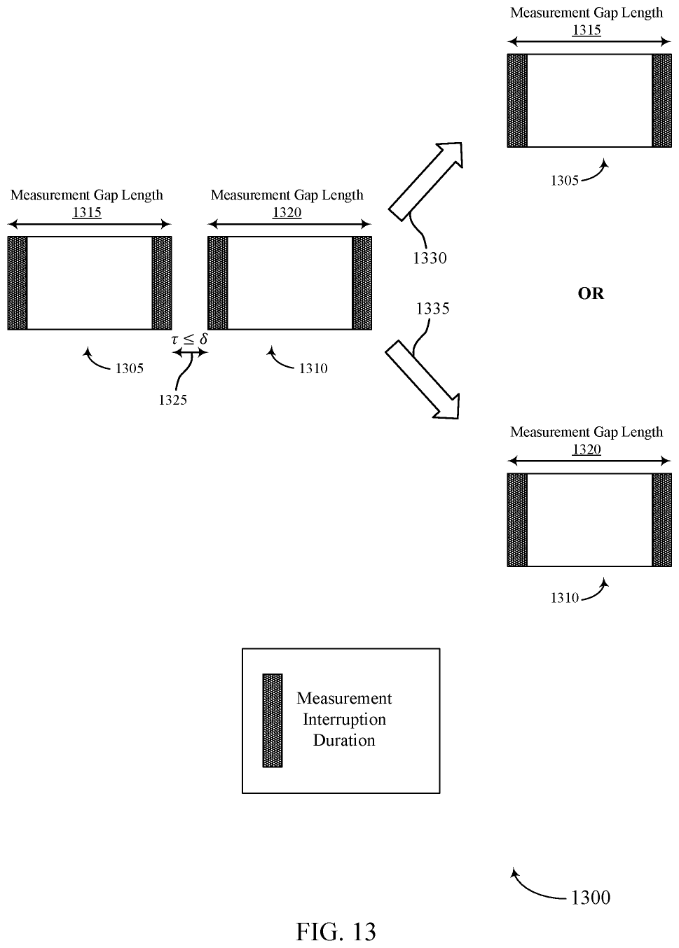

FIG. 13 illustrates an example of a measurement gap sequence configuration 1300 that support techniques for performing measurements using multiple measurement gap occasions in accordance with various aspects of the present disclosure. The measurement gap sequence configuration 1300 may implement aspects of the wireless communications system 100 and the wireless communications system 200 or may be implemented by aspects of the wireless communications system 100 and the wireless communications system 200 as described with reference to FIGS. 1 and 2, respectively. For example, the measurement gap sequence configuration 1300 may be implemented by a UE 115 to support efficient channel measurements at the UE 115. The measurement gap sequence configuration 1300 may further be implemented by a UE 115 to experience power saving by providing improvements to channel measurement reliability and latency.

The measurement gap sequence configuration 1300 may define a nonoverlapping measurement gap sequence configuration. The measurement gap sequence configuration 1300 may include a first measurement gap occasion 1305 associated with a first measurement gap sequence, as well as a second measurement gap occasion 1310 associated with a second measurement gap sequence. One or more of the first measurement gap occasion 1305 or the second measurement gap occasion 1310 may implement aspects of a measurement gap occasion or may be implemented by aspects of a measurement gap occasion as described with reference to FIGS. 1 and 2, respectively.

The first measurement gap occasion 1305 may include a measurement gap length 1315 (also referred to as a measurement gap occasion). Additionally, the first measurement gap occasion 1305 may include at least two measurement interruption durations and measurement period as described with reference to FIGS. 1 through 10, respectively. The second measurement gap occasion 1310 may include a measurement gap length 1320 (also referred to as a measurement gap occasion). Similarly, the second measurement gap occasion 1310 may include at least two measurement interruption durations and measurement period as described with reference to FIGS. 1 through 10, respectively.

In the example of FIG. 13, the first measurement gap occasion 1305 may be within a duration δ 1325 from the second measurement gap occasion 1310. The first measurement gap occasion 1305 and the second measurement gap occasion 1310 may be a duration δ 1325 away from each other. As such, the first measurement gap occasion 1305 and the second measurement gap occasion 1310 may not be contiguous in a time domain (e.g., not back-to-back). For example, a UE 115 may determine that the first measurement gap occasion 1305 is within a duration δ 1325 from the second measurement gap occasion 1310. Based on the determination, the UE 115 may be configured to ignore the first measurement gap occasion 1305 or the second measurement gap occasion 1310. In other words, when two nonoverlapping measurement gap occasions are spaced a duration apart, one of them might cancel the other. As such, only one measurement gap occasion gap may be used by the UE 115 for channel measurements.

The canceling of a measurement gap occasion may enable (e.g., require) coordination between the UE 115 and the network (e.g., a base station 105), so that the UE 115 and the network are in sync (e.g., the base station 105 and the UE 115 are aware of the presence and absence of measurement gap occasions). The UE 115 may be configured to ignore (e.g., cancel) the first measurement gap occasion 1305 at 1330, or the second measurement gap occasion 1310 at 1335, based on a criterion or a criteria. One or more of the criterion or the criteria may include a measurement gap occasion having an earlier or a later start time, a longest or shortest measurement gap occasion, a priority of a measurement gap occasion or a measurement gap sequence, or reference signal measurements associated with a measurement gap occasion or measurement gap sequence, or a combination thereof. Additionally, the UE 115 may be configured to ignore (e.g., cancel) the first measurement gap occasion 1305 at 1330, or the second measurement gap occasion 1310 at 1335, based on an amount of separation (e.g., duration δ 1325 satisfying a threshold) between the first measurement gap occasion 1305 and the second measurement gap occasion 1310.

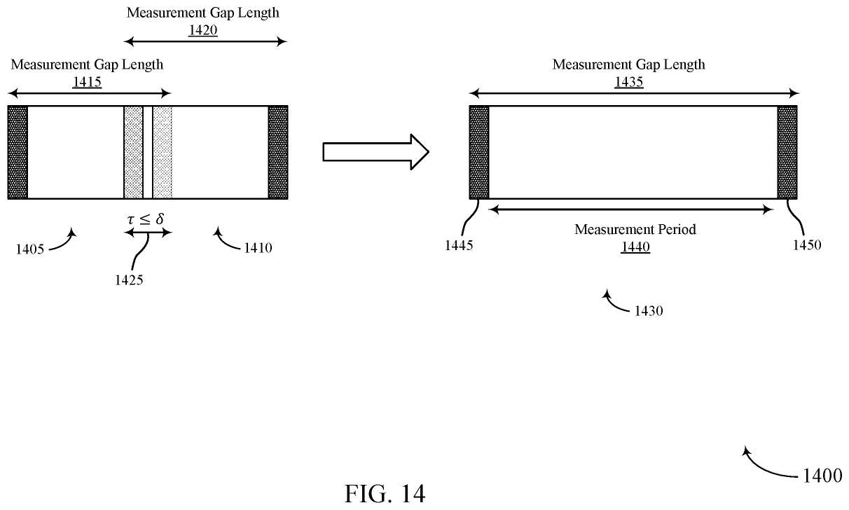

FIG. 14 illustrates an example of a measurement gap sequence configuration 1400 that support techniques for performing measurements using multiple measurement gap occasions in accordance with various aspects of the present disclosure. The measurement gap sequence configuration 1400 may implement aspects of the wireless communications system 100 and the wireless communications system 200 or may be implemented by aspects of the wireless communications system 100 and the wireless communications system 200 as described with reference to FIGS. 1 and 2, respectively. For example, the measurement gap sequence configuration 1400 may be implemented by a UE 115 to support efficient channel measurements at the UE 115. The measurement gap sequence configuration 1400 may further be implemented by a UE 115 to experience power saving by providing improvements to channel measurement reliability and latency.

The measurement gap sequence configuration 1400 may define an overlapping measurement gap sequence configuration. The measurement gap sequence configuration 1400 may include a first measurement gap occasion 1405 associated with a first measurement gap sequence, as well as a second measurement gap occasion 1410 associated with a second measurement gap sequence. One or more of the first measurement gap occasion 1405 or the second measurement gap occasion 1410 may implement aspects of a measurement gap occasion or may be implemented by aspects of a measurement gap occasion as described with reference to FIGS. 1 and 2, respectively.

The first measurement gap occasion 1405 may include a measurement gap length 1415 (also referred to as a measurement gap occasion). Additionally, the first measurement gap occasion 1405 may include at least two measurement interruption durations and measurement period as described with reference to FIGS. 1 through 10, respectively. The second measurement gap occasion 1410 may include a measurement gap length 1420 (also referred to as a measurement gap occasion). Similarly, the second measurement gap occasion 1410 may include at least two measurement interruption durations and measurement period as described with reference to FIGS. 1 through 10, respectively.

In the example of FIG. 14, a portion of the first measurement gap occasion 1405 may overlap with a portion of the second measurement gap occasion 1410. For example, a UE 115 may determine an overlap portion 1425 (e.g., 6) between a portion of the first measurement gap occasion 1405 may overlap with a portion of the second measurement gap occasion 1410. A UE 115 may be configured to aggregate the first measurement gap occasion 1405 and the second measurement gap occasion 1410 to provide a combined measurement gap occasion 1430 (also referred to as an aggregated measurement gap occasion). The combined measurement gap occasion 1430 may include a measurement gap length 1435, which may be a difference between the overlap portion 1425 (e.g., 6) and a combination of the measurement gap length 1415 associated with the first measurement gap occasion 1405 and the measurement gap length 1420 associated with the second measurement gap occasion 1410. In other words, overlapping measurement gap occasions may be merged into a single measurement gap occasion having an aggregate length equal to the sum of the individual measurement gap lengths minus the length of the overlapping portion.

The combined measurement gap occasion 1430 may also include periods at the beginning and at the ending of the combined measurement gap occasion 1430 reserved for interruptions due to RF retuning and reconfiguration. For example, the combined measurement gap occasion 1430 may include the measurement interruption duration 1445 and the measurement interruption duration 1450. That is, the combined measurement gap occasion 1430 may include the beginning measurement interruption duration 1445 associated with the first measurement gap occasion 1405 and the ending measurement interruption duration 1450 associated with the second measurement gap occasion 1410.

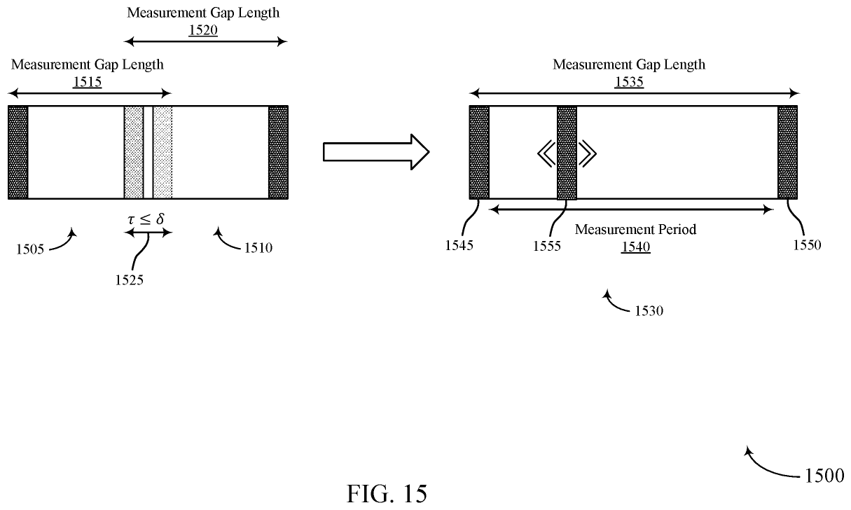

FIG. 15 illustrates an example of a measurement gap sequence configuration 1500 that support techniques for performing measurements using multiple measurement gap occasions in accordance with various aspects of the present disclosure. The measurement gap sequence configuration 1500 may implement aspects of the wireless communications system 100 and the wireless communications system 200 or may be implemented by aspects of the wireless communications system 100 and the wireless communications system 200 as described with reference to FIGS. 1 and 2, respectively. For example, the measurement gap sequence configuration 1400 may be implemented by a UE 115 to support efficient channel measurements at the UE 115. The measurement gap sequence configuration 1500 may further be implemented by a UE 115 to experience power saving by providing improvements to channel measurement reliability and latency.

The measurement gap sequence configuration 1500 may define an overlapping measurement gap sequence configuration. The measurement gap sequence configuration 1500 may include a first measurement gap occasion 1505 associated with a first measurement gap sequence, as well as a second measurement gap occasion 1510 associated with a second measurement gap sequence. One or more of the first measurement gap occasion 1505 or the second measurement gap occasion 1510 may implement aspects of a measurement gap occasion or may be implemented by aspects of a measurement gap occasion as described with reference to FIGS. 1 and 2, respectively.

The first measurement gap occasion 1505 may include a measurement gap length 1515 (also referred to as a measurement gap occasion). Additionally, the first measurement gap occasion 1505 may include at least two measurement interruption durations and measurement period as described with reference to FIGS. 1 through 10, respectively. The second measurement gap occasion 1510 may include a measurement gap length 1520 (also referred to as a measurement gap occasion). Similarly, the second measurement gap occasion 1510 may include at least two measurement interruption durations and measurement period as described with reference to FIGS. 1 through 10, respectively.

In the example of FIG. 15, a portion of the first measurement gap occasion 1505 may overlap with a portion of the second measurement gap occasion 1510. For example, a UE 115 may determine an overlap portion 1525 (e.g., 6) between a portion of the first measurement gap occasion 1505 may overlap with a portion of the second measurement gap occasion 1510. A UE 115 may be configured to aggregate the first measurement gap occasion 1505 and the second measurement gap occasion 1510 to provide a combined measurement gap occasion 1530 (also referred to as an aggregated measurement gap occasion).

The combined measurement gap occasion 1530 may include a measurement gap length 1535, which may be a difference between the overlap portion 1525 (e.g., 6) and a combination of the measurement gap length 1515 associated with the first measurement gap occasion 1505 and the measurement gap length 1520 associated with the second measurement gap occasion 1510. In other words, overlapping measurement gap occasions may be combined into a single measurement gap occasion having an aggregate length equal to the sum of the individual measurement gap lengths minus the length of the overlapping portion.

The combined measurement gap occasion 1530 may also include periods at the beginning and at the ending of the combined measurement gap occasion 1530 reserved for interruptions due to RF retuning and reconfiguration. For example, the combined measurement gap occasion 1530 may include the measurement interruption duration 1545 and the measurement interruption duration 1550. That is, the combined measurement gap occasion 1530 may include the beginning measurement interruption duration 1545 associated with the first measurement gap occasion 1505 and the ending measurement interruption duration 1550 associated with the second measurement gap occasion 1510. In the example of FIG. 15, the combined measurement gap occasion 1530 may also include one or more additional measurement interruption duration, such as the measurement interruption duration 1555. A temporal location of the one or more extra measurement interruption durations, such as the measurement interruption duration 1555 may be variable and dependent on a condition that the measurement time equals a fraction of the aggregate measurement gap length 1535.

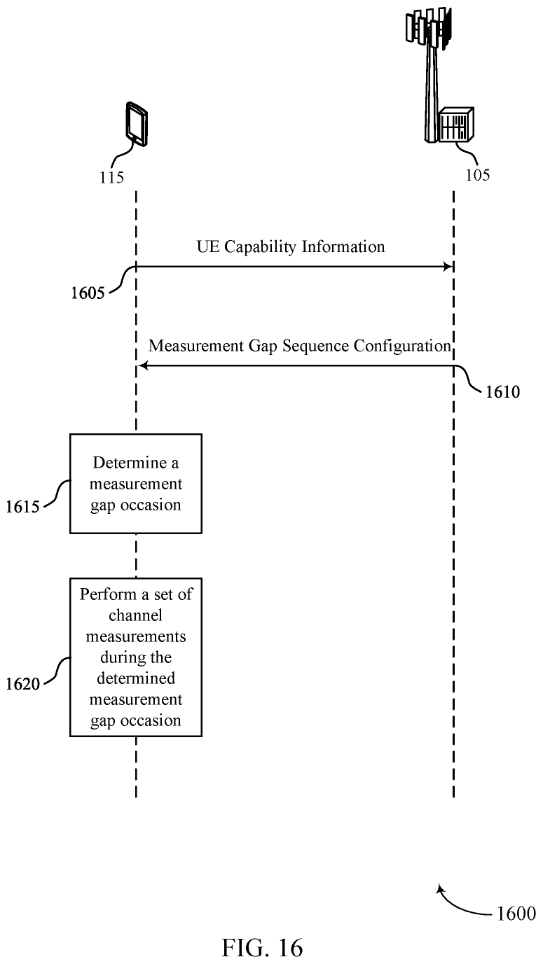

FIG. 16 illustrates an example of a process flow 1600 that supports techniques for performing measurements using multiple measurement gap occasions in accordance with various aspects of the present disclosure. The process flow 1600 may implement aspects of the wireless communications system 100 and the wireless communications system 200 or may be implemented by aspects of the wireless communications system 100 and the wireless communications system 200 as described with reference to FIGS. 1 and 2, respectively. For example, the process flow 1600 may be based on a configuration by a base station 105, which may be implemented by a UE 115. The base station 105 and the UE 115 may be examples of a base station 105 and a UE 115, as described with reference to FIGS. 1 and 2.

The process flow 1600 may be implemented by the UE 115 to support efficient channel measurements at the UE 115. The process flow 1600 may further be implemented by the UE 115 to experience power saving by providing improvements to channel measurement reliability and latency. In the following description of the process flow 1600, the operations may be performed in different orders or at different times. Some operations may also be omitted from the process flow 1600, and other operations may be added to the process flow 1600.

At 1605, the UE 115 may transmit, to the base station 105, UE capability information. The UE capability information may indicate which UE behaviors it supports among those described with reference to FIGS. 3 through 15. Additionally or alternatively, the UE 115 may be configured to support UE behaviors as described with reference to FIGS. 3 through 15 based on one or more of an RRC configuration (including measurement configurations and requirements, objectives) or an active BWP. At 1610, the base station 105 may transmit, to the UE 115, control signaling indicating a measurement gap sequence configuration based on the UE capability information. The control signaling may include an RRC message, a downlink control information (DCI) message, or a MAC control element (MAC-CE) message.

At 1615, the UE 115 may determine a measurement gap occasion based on the measurement gap sequence configuration. The measurement gap occasion may include one or more of a first measurement gap occasion associated with a first measurement gap sequence, a second measurement gap occasion associated with a second measurement gap sequence, or a combination of the first measurement gap occasion and the second measurement gap occasion. At 1620, the UE 115 may perform a set of channel measurements during the determined measurement gap occasion. For example, the UE 115 may perform measurements of signals (e.g., reference signals) from the base station 105 or other neighboring devices.

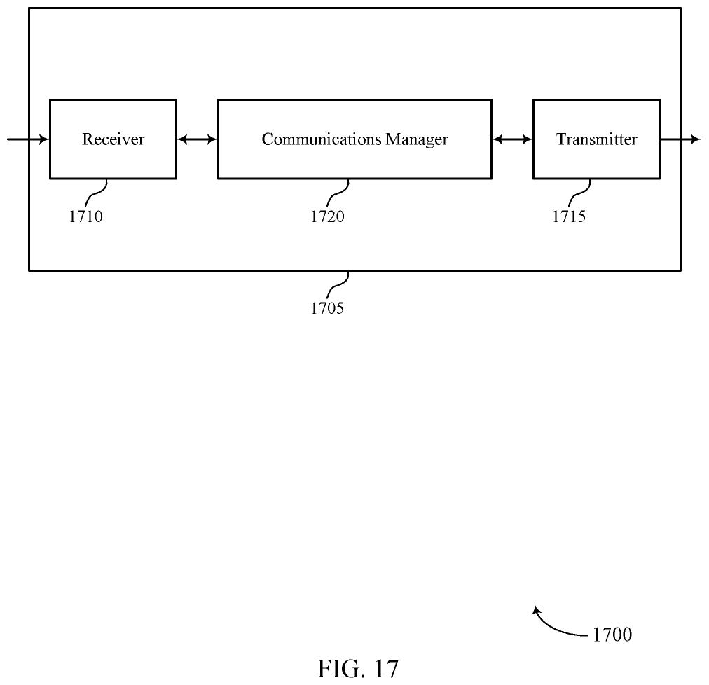

FIG. 17 shows a block diagram 1700 of a device 1705 that supports techniques for performing measurements using multiple measurement gap occasions in accordance with various aspects of the present disclosure. The device 1705 may be an example of aspects of a UE 115 as described herein. The device 1705 may include a receiver 1710, a transmitter 1715, and a communications manager 1720. The device 1705 may also include a processor. Each of these components may be in communication with one another (e.g., via one or more buses).

The receiver 1710 may provide a means for receiving information such as packets, user data, control information, or any combination thereof associated with various information channels (e.g., control channels, data channels, information channels related to techniques for performing measurements using multiple measurement gap occasions). Information may be passed on to other components of the device 1705. The receiver 1710 may utilize a single antenna or a set of multiple antennas.

The transmitter 1715 may provide a means for transmitting signals generated by other components of the device 1705. For example, the transmitter 1715 may transmit information such as packets, user data, control information, or any combination thereof associated with various information channels (e.g., control channels, data channels, information channels related to techniques for performing measurements using multiple measurement gap occasions). In some examples, the transmitter 1715 may be co-located with a receiver 1710 in a transceiver. The transmitter 1715 may utilize a single antenna or a set of multiple antennas.

The communications manager 1720, the receiver 1710, the transmitter 1715, or various combinations thereof or various components thereof may be examples of means for performing various aspects of techniques for performing measurements using multiple measurement gap occasions as described herein. For example, the communications manager 1720, the receiver 1710, the transmitter 1715, or various combinations or components thereof may support a method for performing one or more of the functions described herein.

In some examples, the communications manager 1720, the receiver 1710, the transmitter 1715, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1720, the receiver 1710, the transmitter 1715, or various combinations or components thereof may be implemented in code (e.g., as communications management software or firmware) executed by a processor. If implemented in code executed by a processor, the functions of the communications manager 1720, the receiver 1710, the transmitter 1715, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 1720 may be configured to perform various operations (e.g., receiving, monitoring, transmitting) using or otherwise in cooperation with the receiver 1710, the transmitter 1715, or both. For example, the communications manager 1720 may receive information from the receiver 1710, send information to the transmitter 1715, or be integrated in combination with the receiver 1710, the transmitter 1715, or both to receive information, transmit information, or perform various other operations as described herein.

The communications manager 1720 may support wireless communication at the device 1705 (e.g., a UE) in accordance with examples as disclosed herein. For example, the communications manager 1720 may be configured as or otherwise support a means for transmitting, to a base station, signaling indicating UE capability information. The communications manager 1720 may be configured as or otherwise support a means for receiving, from the base station, control signaling indicating a measurement gap sequence configuration based on the UE capability information. The communications manager 1720 may be configured as or otherwise support a means for determining a measurement gap occasion based on the measurement gap sequence configuration, the measurement gap occasion including one or more of a first measurement gap occasion associated with a first measurement gap sequence, a second measurement gap occasion associated with a second measurement gap sequence, or a combination of the first measurement gap occasion and the second measurement gap occasion. The communications manager 1720 may be configured as or otherwise support a means for performing a set of channel measurements during the determined measurement gap occasion.

By including or configuring the communications manager 1720 in accordance with examples as described herein, the device 1705 (e.g., a processor controlling or otherwise coupled to the receiver 1710, the transmitter 1715, the communications manager 1720, or a combination thereof) may support techniques for reduced power consumption by improving the reliability and reducing latency of performing channel measurements as described herein.

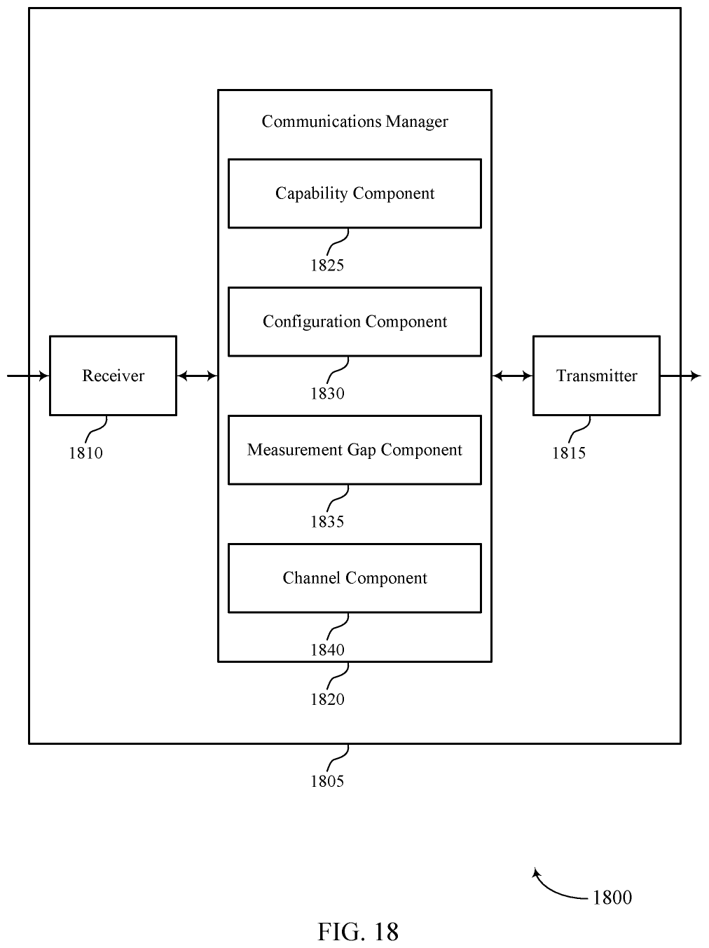

FIG. 18 shows a block diagram 1800 of a device 1805 that supports techniques for performing measurements using multiple measurement gap occasions in accordance with various aspects of the present disclosure. The device 1805 may be an example of aspects of a device 1705 or a UE 115 as described herein. The device 1805 may include a receiver 1810, a transmitter 1815, and a communications manager 1820. The device 1805 may also include a processor. Each of these components may be in communication with one another (e.g., via one or more buses).

The receiver 1810 may provide a means for receiving information such as packets, user data, control information, or any combination thereof associated with various information channels (e.g., control channels, data channels, information channels related to techniques for performing measurements using multiple measurement gap occasions). Information may be passed on to other components of the device 1805. The receiver 1810 may utilize a single antenna or a set of multiple antennas.

The transmitter 1815 may provide a means for transmitting signals generated by other components of the device 1805. For example, the transmitter 1815 may transmit information such as packets, user data, control information, or any combination thereof associated with various information channels (e.g., control channels, data channels, information channels related to techniques for performing measurements using multiple measurement gap occasions). In some examples, the transmitter 1815 may be co-located with a receiver 1810 in a transceiver. The transmitter 1815 may utilize a single antenna or a set of multiple antennas.

The device 1805, or various components thereof, may be an example of means for performing various aspects of techniques for performing measurements using multiple measurement gap occasions as described herein. For example, the communications manager 1820 may include a capability component 1825, a configuration component 1830, a measurement gap component 1835, a channel component 1840, or any combination thereof. The communications manager 1820 may be an example of aspects of a communications manager 1720 as described herein. In some examples, the communications manager 1820, or various components thereof, may be configured to perform various operations (e.g., receiving, monitoring, transmitting) using or otherwise in cooperation with the receiver 1810, the transmitter 1815, or both. For example, the communications manager 1820 may receive information from the receiver 1810, send information to the transmitter 1815, or be integrated in combination with the receiver 1810, the transmitter 1815, or both to receive information, transmit information, or perform various other operations as described herein.

The communications manager 1820 may support wireless communication at the device 1805 (e.g., a UE) in accordance with examples as disclosed herein. The capability component 1825 may be configured as or otherwise support a means for transmitting, to a base station, signaling indicating UE capability information. The configuration component 1830 may be configured as or otherwise support a means for receiving, from the base station, control signaling indicating a measurement gap sequence configuration based on the UE capability information. The measurement gap component 1835 may be configured as or otherwise support a means for determining a measurement gap occasion based on the measurement gap sequence configuration, the measurement gap occasion including one or more of a first measurement gap occasion associated with a first measurement gap sequence, a second measurement gap occasion associated with a second measurement gap sequence, or a combination of the first measurement gap occasion and the second measurement gap occasion. The channel component 1840 may be configured as or otherwise support a means for performing a set of channel measurements during the determined measurement gap occasion.

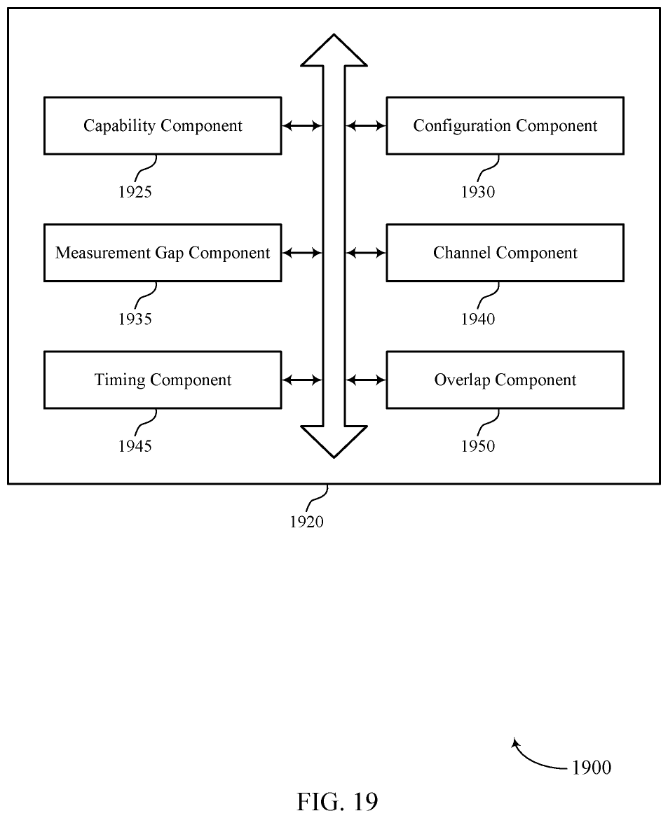

FIG. 19 shows a block diagram 1900 of a communications manager 1920 that supports techniques for performing measurements using multiple measurement gap occasions in accordance with various aspects of the present disclosure. The communications manager 1920 may be an example of aspects of a communications manager 1720, a communications manager 1820, or both, as described herein. The communications manager 1920, or various components thereof, may be an example of means for performing various aspects of techniques for performing measurements using multiple measurement gap occasions as described herein. For example, the communications manager 1920 may include a capability component 1925, a configuration component 1930, a measurement gap component 1935, a channel component 1940, a timing component 1945, an overlap component 1950, or any combination thereof. Each of these components may communicate, directly or indirectly, with one another (e.g., via one or more buses).

The communications manager 1920 may support wireless communication at a UE in accordance with examples as disclosed herein. The capability component 1925 may be configured as or otherwise support a means for transmitting, to a base station, signaling indicating UE capability information. The configuration component 1930 may be configured as or otherwise support a means for receiving, from the base station, control signaling indicating a measurement gap sequence configuration based on the UE capability information. The measurement gap component 1935 may be configured as or otherwise support a means for determining a measurement gap occasion based on the measurement gap sequence configuration. The measurement gap occasion including one or more of a first measurement gap occasion associated with a first measurement gap sequence, a second measurement gap occasion associated with a second measurement gap sequence, or a combination of the first measurement gap occasion and the second measurement gap occasion. The channel component 1940 may be configured as or otherwise support a means for performing a set of channel measurements during the determined measurement gap occasion.

In some examples, the measurement gap component 1935 may be configured as or otherwise support a means for aggregating a subset of measurement gap occasions based on the measurement gap sequence configuration. In some examples, the aggregated subset of measurement gap occasions includes a first measurement interruption duration associated with the first measurement gap occasion and occurring at a beginning of the first measurement gap occasion, a second measurement interruption duration associated with the second measurement gap occasion and occurring at an ending of the second measurement gap occasion, and a measurement gap duration associated with the first measurement gap occasion and the second measurement gap occasion. In some examples, the measurement gap duration is a combined measurement gap duration including a first measurement gap duration associated with the first measurement gap occasion and a second measurement gap duration associated with the second measurement gap occasion.

In some examples, the timing component 1945 may be configured as or otherwise support a means for assigning a third measurement interruption duration in the measurement gap duration based on the measurement gap sequence configuration, the measurement gap duration is a combined measurement gap duration including a first measurement gap duration associated with the first measurement gap occasion and a second measurement gap duration associated with the second measurement gap occasion. In some examples, the aggregated subset of measurement gap occasions includes the first measurement interruption duration, the second measurement interruption duration, and the third measurement interruption duration. In some examples, the timing component 1945 may be configured as or otherwise support a means for determining a temporal location for the third measurement interruption duration in the measurement gap duration based on one or more of the first measurement interruption duration, the second measurement interruption duration, or the third measurement interruption duration satisfying a threshold.

In some examples, the first measurement gap occasion and the second measurement gap occasion are one or more of contiguous or overlapping in a time domain. In some examples, the first measurement gap occasion and the second measurement gap occasion are one or more of noncontiguous or nonoverlapping in a time domain. In some examples, the timing component 1945 may be configured as or otherwise support a means for determining a duration between the first measurement gap occasion and the second measurement gap occasion. In some examples, the measurement gap component 1935 may be configured as or otherwise support a means for aggregating a subset of measurement gap occasions including the first measurement gap occasion and the second measurement gap occasion based on determining that the duration between the first measurement gap occasion and the second measurement gap occasion satisfies a threshold. In some examples, the channel component 1940 may be configured as or otherwise support a means for performing the set of channel measurements during the aggregated subset of measurement gap occasions. In some examples, a measurement gap duration associated with the aggregated subset of measurement gap occasions includes a first measurement gap duration associated with the first measurement gap occasion, a second measurement gap duration associated with the second measurement gap occasion, and the duration between the first measurement gap occasion and the second measurement gap occasion.

In some examples, the measurement gap component 1935 may be configured as or otherwise support a means for ignoring the first measurement gap occasion or the second measurement gap occasion based on one or more of a criterion or that the duration between the first measurement gap occasion and the second measurement gap occasion satisfies the threshold. In some examples, the criterion includes one or more of the first measurement gap occasion beginning before or after the second measurement gap occasion, a first measurement duration associated with the first measurement gap occasion is greater or less than a second measurement duration associated with the second measurement gap occasion, a first priority associated with the first measurement gap occasion is higher or lower than a second priority associated with the second measurement gap occasion, or a first reference signal measurement associated with the first measurement gap occasion and a second reference signal measurement associated with the second measurement gap occasion. In some examples, the criterion includes one or more of an RRC configuration, an active BWP, or the UE capability information.

In some examples, the overlap component 1950 may be configured as or otherwise support a means for determining an overlap portion between a first portion of the first measurement gap occasion and a second portion of the second measurement gap occasion. In some examples, the channel component 1940 may be configured as or otherwise support a means for performing the set of channel measurements based on the determining of the overlap portion between the first portion of the first measurement gap occasion and the second portion of the second measurement gap occasion. In some examples, the overlap component 1950 may be configured as or otherwise support a means for assigning the overlap portion to the first measurement gap occasion or the second measurement gap occasion based on a criterion. In some examples, the channel component 1940 may be configured as or otherwise support a means for performing the set of channel measurements based on the assigning of the overlap portion to the first measurement gap occasion or the second measurement gap occasion.

In some examples, the criterion includes one or more of the first measurement gap occasion beginning before or after the second measurement gap occasion, a first measurement duration associated with the first measurement gap occasion is greater or less than a second measurement duration associated with the second measurement gap occasion, a first priority associated with the first measurement gap occasion is higher or lower than a second priority associated with the second measurement gap occasion, or a first reference signal measurement associated with the first measurement gap occasion and a second reference signal measurement associated with the second measurement gap occasion. In some examples, the criterion includes one or more of an RRC configuration, an active BWP, or the UE capability information.

In some examples, the measurement gap component 1935 may be configured as or otherwise support a means for ignoring the first measurement gap occasion or the second measurement gap occasion based on the determining of the overlap portion between the first portion of the first measurement gap occasion and the second portion of the second measurement gap occasion. In some examples, the measurement gap component 1935 may be configured as or otherwise support a means for aggregating a subset of measurement gap occasions including the first measurement gap occasion and the second measurement gap occasion based on the determining of the overlap portion between the first portion of the first measurement gap occasion and the second portion of the second measurement gap occasion. In some examples, the channel component 1940 may be configured as or otherwise support a means for performing the set of channel measurements during the aggregated subset of measurement gap occasions.

In some examples, a measurement gap duration of the aggregated subset of measurement gap occasions is based on a first measurement gap duration associated with the first measurement gap occasion, a second measurement gap duration associated with the second measurement gap occasion, and the overlap portion between the first portion of the first measurement gap occasion and the second portion of the second measurement gap occasion, the measurement gap duration including one or more of a first measurement interruption duration associated with the first measurement gap occasion, a second measurement interruption duration associated with the second measurement gap occasion, or a third measurement interruption duration associated with the aggregated subset of measurement gap occasions. In some examples, the control signaling includes RRC signaling and the measurement gap sequence configuration indicates one or more of a beginning of the measurement gap occasion or a number of measurement gap occasions associated with a measurement gap sequence including the measurement gap occasion.

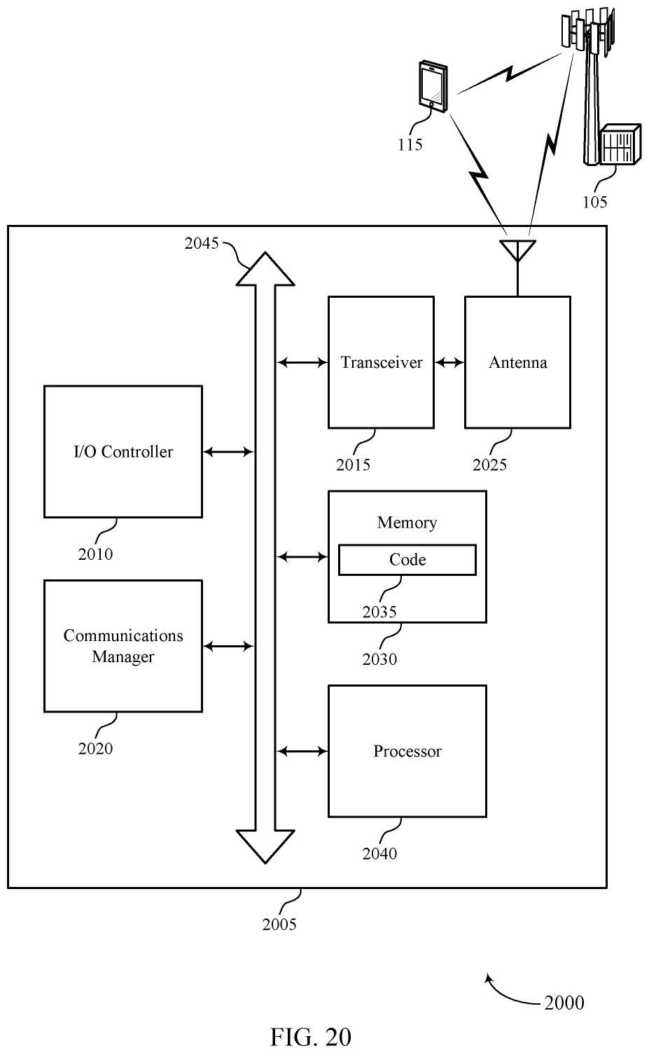

FIG. 20 shows a diagram of a system 2000 including a device 2005 that supports techniques for performing measurements using multiple measurement gap occasions in accordance with various aspects of the present disclosure. The device 2005 may be an example of or include the components of a device 1705, a device 1805, or a UE 115 as described herein. The device 2005 may communicate wirelessly with one or more base stations 105, UEs 115, or any combination thereof. The device 2005 may include components for bi-directional voice and data communications including components for transmitting and receiving communications, such as a communications manager 2020, an input/output (I/O) controller 2010, a transceiver 2015, an antenna 2025, a memory 2030, code 2035, and a processor 2040. These components may be in electronic communication or otherwise coupled (e.g., operatively, communicatively, functionally, electronically, electrically) via one or more buses (e.g., a bus 2045).

The I/O controller 2010 may manage input and output signals for the device 2005. The I/O controller 2010 may also manage peripherals not integrated into the device 2005. In some cases, the I/O controller 2010 may represent a physical connection or port to an external peripheral. In some cases, the I/O controller 2010 may utilize an operating system such as iOS®, ANDROID®, MS-DOS®, MS-WINDOWS®, OS/2®, UNIX®, LINUX®, or another known operating system. Additionally or alternatively, the I/O controller 2010 may represent or interact with a modem, a keyboard, a mouse, a touchscreen, or a similar device. In some cases, the I/O controller 2010 may be implemented as part of a processor, such as the processor 2040. In some cases, a user may interact with the device 2005 via the I/O controller 2010 or via hardware components controlled by the I/O controller 2010.

In some cases, the device 2005 may include a single antenna 2025. However, in some other cases, the device 2005 may have more than one antenna 2025, which may be capable of concurrently transmitting or receiving multiple wireless transmissions. The transceiver 2015 may communicate bi-directionally, via the one or more antennas 2025, wired, or wireless links as described herein. For example, the transceiver 2015 may represent a wireless transceiver and may communicate bi-directionally with another wireless transceiver. The transceiver 2015 may also include a modem to modulate the packets, to provide the modulated packets to one or more antennas 2025 for transmission, and to demodulate packets received from the one or more antennas 2025. The transceiver 2015, or the transceiver 2015 and one or more antennas 2025, may be an example of a transmitter 1715, a transmitter 1815, a receiver 1710, a receiver 1810, or any combination thereof or component thereof, as described herein.

The memory 2030 may include random access memory (RAM) and read-only memory (ROM). The memory 2030 may store computer-readable, computer-executable code 2035 including instructions that, when executed by the processor 2040, cause the device 2005 to perform various functions described herein. The code 2035 may be stored in a non-transitory computer-readable medium such as system memory or another type of memory. In some cases, the code 2035 may not be directly executable by the processor 2040 but may cause a computer (e.g., when compiled and executed) to perform functions described herein. In some cases, the memory 2030 may contain, among other things, a basic I/O system (BIOS) which may control basic hardware or software operation such as the interaction with peripheral components or devices.

The processor 2040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 2040 may be configured to operate a memory array using a memory controller. In some other cases, a memory controller may be integrated into the processor 2040. The processor 2040 may be configured to execute computer-readable instructions stored in a memory (e.g., the memory 2030) to cause the device 2005 to perform various functions (e.g., functions or tasks supporting techniques for performing measurements using multiple measurement gap occasions). For example, the device 2005 or a component of the device 2005 may include a processor 2040 and memory 2030 coupled to the processor 2040, the processor 2040 and memory 2030 configured to perform various functions described herein.

The communications manager 2020 may support wireless communication at the device 2005 (e.g., a UE) in accordance with examples as disclosed herein. For example, the communications manager 2020 may be configured as or otherwise support a means for transmitting, to a base station, signaling indicating UE capability information. The communications manager 2020 may be configured as or otherwise support a means for receiving, from the base station, control signaling indicating a measurement gap sequence configuration based on the UE capability information. The communications manager 2020 may be configured as or otherwise support a means for determining a measurement gap occasion based on the measurement gap sequence configuration. The measurement gap occasion including one or more of a first measurement gap occasion associated with a first measurement gap sequence, a second measurement gap occasion associated with a second measurement gap sequence, or a combination of the first measurement gap occasion and the second measurement gap occasion. The communications manager 2020 may be configured as or otherwise support a means for performing a set of channel measurements during the determined measurement gap occasion. By including or configuring the communications manager 2020 in accordance with examples as described herein, the device 2005 may support techniques for improved communication reliability, reduced latency, improved coordination between devices, and longer battery life.

In some examples, the communications manager 2020 may be configured to perform various operations (e.g., receiving, monitoring, transmitting) using or otherwise in cooperation with the transceiver 2015, the one or more antennas 2025, or any combination thereof. Although the communications manager 2020 is illustrated as a separate component, in some examples, one or more functions described with reference to the communications manager 2020 may be supported by or performed by the processor 2040, the memory 2030, the code 2035, or any combination thereof. For example, the code 2035 may include instructions executable by the processor 2040 to cause the device 2005 to perform various aspects of techniques for performing measurements using multiple measurement gap occasions as described herein, or the processor 2040 and the memory 2030 may be otherwise configured to perform or support such operations.

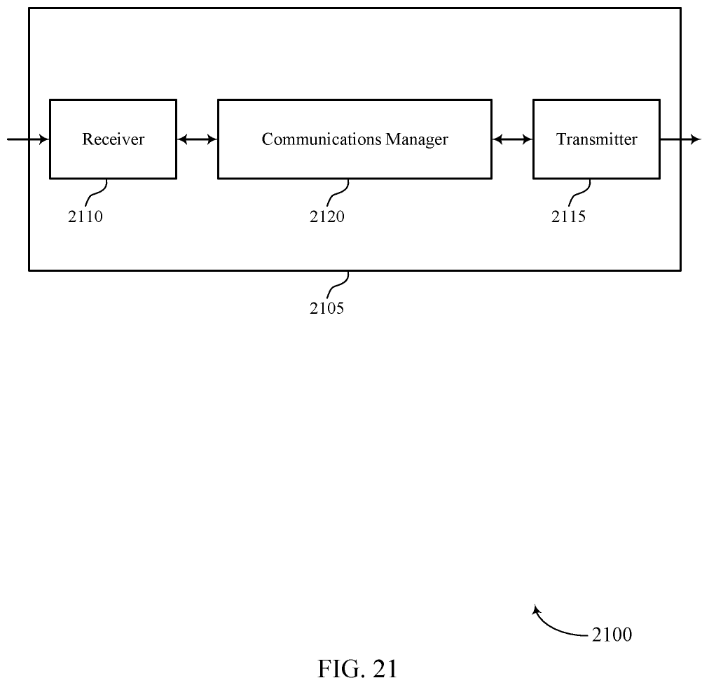

FIG. 21 shows a block diagram 2100 of a device 2105 that supports techniques for performing measurements using multiple measurement gap occasions in accordance with various aspects of the present disclosure. The device 2105 may be an example of aspects of a base station 105 as described herein. The device 2105 may include a receiver 2110, a transmitter 2115, and a communications manager 2120. The device 2105 may also include a processor. Each of these components may be in communication with one another (e.g., via one or more buses).

The receiver 2110 may provide a means for receiving information such as packets, user data, control information, or any combination thereof associated with various information channels (e.g., control channels, data channels, information channels related to techniques for performing measurements using multiple measurement gap occasions). Information may be passed on to other components of the device 2105. The receiver 2110 may utilize a single antenna or a set of multiple antennas.

The transmitter 2115 may provide a means for transmitting signals generated by other components of the device 2105. For example, the transmitter 2115 may transmit information such as packets, user data, control information, or any combination thereof associated with various information channels (e.g., control channels, data channels, information channels related to techniques for performing measurements using multiple measurement gap occasions). In some examples, the transmitter 2115 may be co-located with a receiver 2110 in a transceiver. The transmitter 2115 may utilize a single antenna or a set of multiple antennas.

The communications manager 2120, the receiver 2110, the transmitter 2115, or various combinations thereof or various components thereof may be examples of means for performing various aspects of techniques for performing measurements using multiple measurement gap occasions as described herein. For example, the communications manager 2120, the receiver 2110, the transmitter 2115, or various combinations or components thereof may support a method for performing one or more of the functions described herein.

In some examples, the communications manager 2120, the receiver 2110, the transmitter 2115, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 2120, the receiver 2110, the transmitter 2115, or various combinations or components thereof may be implemented in code (e.g., as communications management software or firmware) executed by a processor. If implemented in code executed by a processor, the functions of the communications manager 2120, the receiver 2110, the transmitter 2115, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 2120 may be configured to perform various operations (e.g., receiving, monitoring, transmitting) using or otherwise in cooperation with the receiver 2110, the transmitter 2115, or both. For example, the communications manager 2120 may receive information from the receiver 2110, send information to the transmitter 2115, or be integrated in combination with the receiver 2110, the transmitter 2115, or both to receive information, transmit information, or perform various other operations as described herein.

The communications manager 2120 may support wireless communication at the device 2105 (e.g., a base station) in accordance with examples as disclosed herein. For example, the communications manager 2120 may be configured as or otherwise support a means for receiving, from a UE, signaling indicating UE capability information. The communications manager 2120 may be configured as or otherwise support a means for transmitting, to the UE, control signaling indicating a measurement gap sequence configuration based on the UE capability information. The communications manager 2120 may be configured as or otherwise support a means for performing a set of reference signal transmissions for a set of channel measurements during a measurement gap occasion associated with the measurement gap sequence configuration, the measurement gap occasion including one or more of a first measurement gap occasion associated with a first measurement gap sequence, a second measurement gap occasion associated with a second measurement gap sequence, or a combination of the first measurement gap occasion and the second measurement gap occasion.

By including or configuring the communications manager 2120 in accordance with examples as described herein, the device 2105 (e.g., a processor controlling or otherwise coupled to the receiver 2110, the transmitter 2115, the communications manager 2120, or a combination thereof) may support techniques for reduced power consumption.

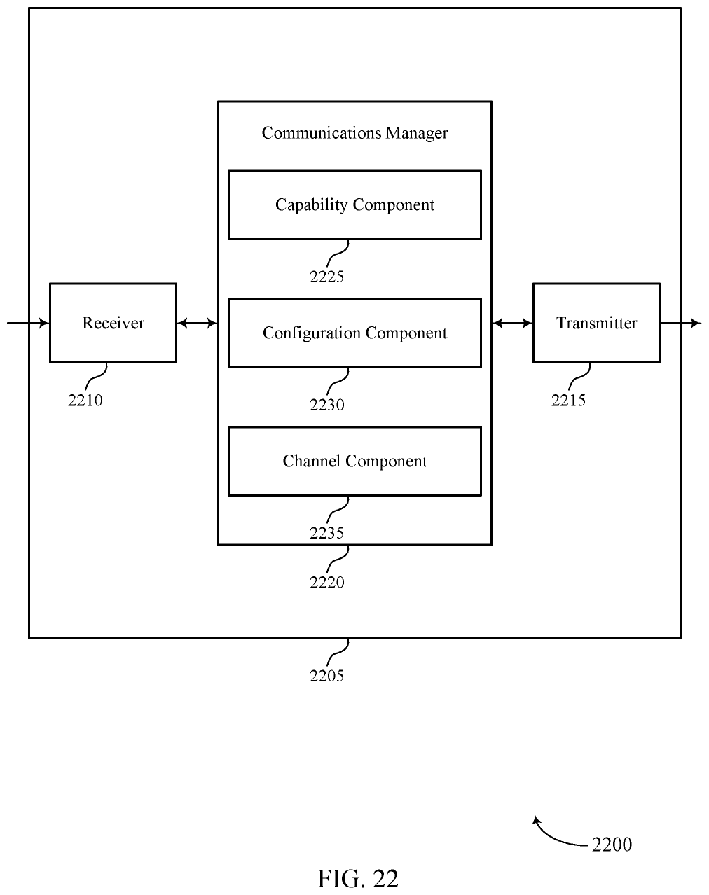

FIG. 22 shows a block diagram 2200 of a device 2205 that supports techniques for performing measurements using multiple measurement gap occasions in accordance with various aspects of the present disclosure. The device 2205 may be an example of aspects of a device 2105 or a base station 105 as described herein. The device 2205 may include a receiver 2210, a transmitter 2215, and a communications manager 2220. The device 2205 may also include a processor. Each of these components may be in communication with one another (e.g., via one or more buses).

The receiver 2210 may provide a means for receiving information such as packets, user data, control information, or any combination thereof associated with various information channels (e.g., control channels, data channels, information channels related to techniques for performing measurements using multiple measurement gap occasions). Information may be passed on to other components of the device 2205. The receiver 2210 may utilize a single antenna or a set of multiple antennas.

The transmitter 2215 may provide a means for transmitting signals generated by other components of the device 2205. For example, the transmitter 2215 may transmit information such as packets, user data, control information, or any combination thereof associated with various information channels (e.g., control channels, data channels, information channels related to techniques for performing measurements using multiple measurement gap occasions). In some examples, the transmitter 2215 may be co-located with a receiver 2210 in a transceiver. The transmitter 2215 may utilize a single antenna or a set of multiple antennas.

The device 2205, or various components thereof, may be an example of means for performing various aspects of techniques for performing measurements using multiple measurement gap occasions as described herein. For example, the communications manager 2220 may include a capability component 2225, a configuration component 2230, a channel component 2235, or any combination thereof. The communications manager 2220 may be an example of aspects of a communications manager 2120 as described herein. In some examples, the communications manager 2220, or various components thereof, may be configured to perform various operations (e.g., receiving, monitoring, transmitting) using or otherwise in cooperation with the receiver 2210, the transmitter 2215, or both. For example, the communications manager 2220 may receive information from the receiver 2210, send information to the transmitter 2215, or be integrated in combination with the receiver 2210, the transmitter 2215, or both to receive information, transmit information, or perform various other operations as described herein.

The communications manager 2220 may support wireless communication at the 2205 (e.g., a base station) in accordance with examples as disclosed herein. The capability component 2225 may be configured as or otherwise support a means for receiving, from a UE, signaling indicating UE capability information. The configuration component 2230 may be configured as or otherwise support a means for transmitting, to the UE, control signaling indicating a measurement gap sequence configuration based on the UE capability information. The channel component 2235 may be configured as or otherwise support a means for performing a set of reference signal transmissions for a set of channel measurements during a measurement gap occasion associated with the measurement gap sequence configuration, the measurement gap occasion including one or more of a first measurement gap occasion associated with a first measurement gap sequence, a second measurement gap occasion associated with a second measurement gap sequence, or a combination of the first measurement gap occasion and the second measurement gap occasion.

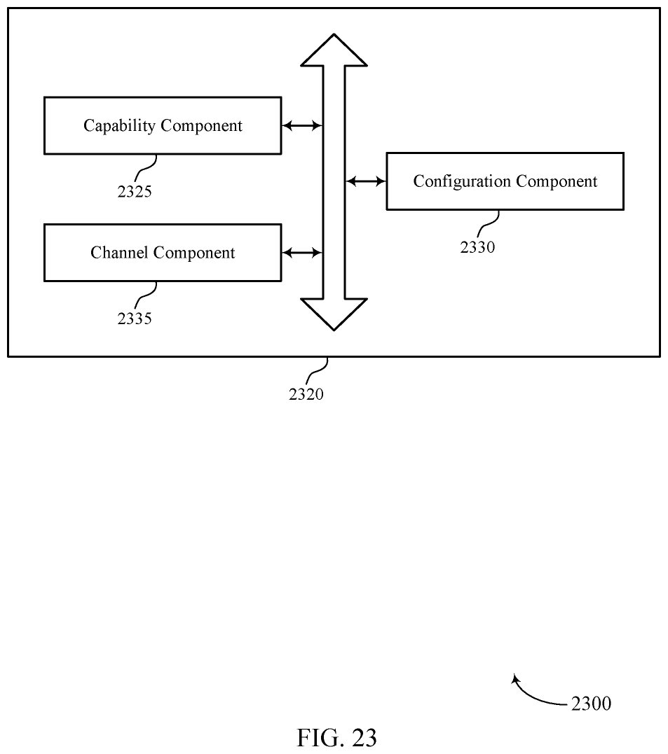

FIG. 23 shows a block diagram 2300 of a communications manager 2320 that supports techniques for performing measurements using multiple measurement gap occasions in accordance with various aspects of the present disclosure. The communications manager 2320 may be an example of aspects of a communications manager 2120, a communications manager 2220, or both, as described herein. The communications manager 2320, or various components thereof, may be an example of means for performing various aspects of techniques for performing measurements using multiple measurement gap occasions as described herein. For example, the communications manager 2320 may include a capability component 2325, a configuration component 2330, a channel component 2335, or any combination thereof. Each of these components may communicate, directly or indirectly, with one another (e.g., via one or more buses).

The communications manager 2320 may support wireless communication at a base station in accordance with examples as disclosed herein. The capability component 2325 may be configured as or otherwise support a means for receiving, from a UE, signaling indicating UE capability information. The configuration component 2330 may be configured as or otherwise support a means for transmitting, to the UE, control signaling indicating a measurement gap sequence configuration based on the UE capability information. The channel component 2335 may be configured as or otherwise support a means for performing a set of reference signal transmissions for a set of channel measurements during a measurement gap occasion associated with the measurement gap sequence configuration. The measurement gap occasion including one or more of a first measurement gap occasion associated with a first measurement gap sequence, a second measurement gap occasion associated with a second measurement gap sequence, or a combination of the first measurement gap occasion and the second measurement gap occasion.

In some examples, the measurement gap occasion includes an aggregated subset of measurement gap occasions including a first measurement interruption duration associated with the first measurement gap occasion, a second measurement interruption duration associated with the second measurement gap occasion, and a measurement gap duration associated with the first measurement gap occasion and the second measurement gap occasion. In some examples, the measurement gap duration includes a first measurement gap duration associated with the first measurement gap occasion and a second measurement gap duration associated with the second measurement gap occasion. In some examples, the aggregated subset of measurement gap occasions includes the first measurement interruption duration, the second measurement interruption duration, and a third measurement interruption duration.

In some examples, the first measurement gap occasion and the second measurement gap occasion are one or more of contiguous or overlapping in a time domain. In some examples, the first measurement gap occasion and the second measurement gap occasion are noncontiguous or nonoverlapping in a time domain. In some examples, the control signaling includes RRC signaling and the measurement gap sequence configuration indicates one or more of a beginning of the measurement gap occasion or a number of measurement gap occasions associated with a measurement gap sequence including the measurement gap occasion. In some examples, the measurement gap duration includes a first measurement gap duration associated with the first measurement gap occasion, a second measurement gap duration associated with the second measurement gap occasion, and a duration between the first measurement gap occasion and the second measurement gap occasion.

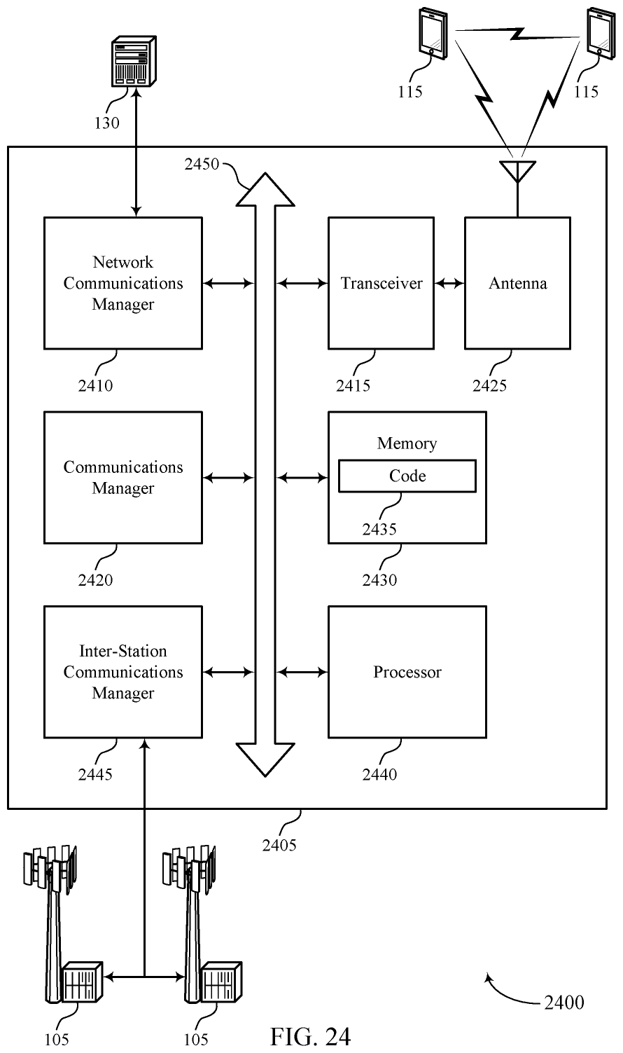

FIG. 24 shows a diagram of a system 2400 including a device 2405 that supports techniques for performing measurements using multiple measurement gap occasions in accordance with various aspects of the present disclosure. The device 2405 may be an example of or include the components of a device 2105, a device 2205, or a base station 105 as described herein. The device 2405 may communicate wirelessly with one or more base stations 105, UEs 115, or any combination thereof. The device 2405 may include components for bi-directional voice and data communications including components for transmitting and receiving communications, such as a communications manager 2420, a network communications manager 2410, a transceiver 2415, an antenna 2425, a memory 2430, code 2435, a processor 2440, and an inter-station communications manager 2445. These components may be in electronic communication or otherwise coupled (e.g., operatively, communicatively, functionally, electronically, electrically) via one or more buses (e.g., a bus 2450).

The network communications manager 2410 may manage communications with a core network 130 (e.g., via one or more wired backhaul links). For example, the network communications manager 2410 may manage the transfer of data communications for client devices, such as one or more UEs 115.

In some cases, the device 2405 may include a single antenna 2425. However, in some other cases the device 2405 may have more than one antenna 2425, which may be capable of concurrently transmitting or receiving multiple wireless transmissions. The transceiver 2415 may communicate bi-directionally, via the one or more antennas 2425, wired, or wireless links as described herein. For example, the transceiver 2415 may represent a wireless transceiver and may communicate bi-directionally with another wireless transceiver. The transceiver 2415 may also include a modem to modulate the packets, to provide the modulated packets to one or more antennas 2425 for transmission, and to demodulate packets received from the one or more antennas 2425. The transceiver 2415, or the transceiver 2415 and one or more antennas 2425, may be an example of a transmitter 2115, a transmitter 2215, a receiver 2110, a receiver 2210, or any combination thereof or component thereof, as described herein.

The memory 2430 may include RAM and ROM. The memory 2430 may store computer-readable, computer-executable code 2435 including instructions that, when executed by the processor 2440, cause the device 2405 to perform various functions described herein. The code 2435 may be stored in a non-transitory computer-readable medium such as system memory or another type of memory. In some cases, the code 2435 may not be directly executable by the processor 2440 but may cause a computer (e.g., when compiled and executed) to perform functions described herein. In some cases, the memory 2430 may contain, among other things, a BIOS which may control basic hardware or software operation such as the interaction with peripheral components or devices.

The processor 2440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 2440 may be configured to operate a memory array using a memory controller. In some other cases, a memory controller may be integrated into the processor 2440. The processor 2440 may be configured to execute computer-readable instructions stored in a memory (e.g., the memory 2430) to cause the device 2405 to perform various functions (e.g., functions or tasks supporting techniques for performing measurements using multiple measurement gap occasions). For example, the device 2405 or a component of the device 2405 may include a processor 2440 and memory 2430 coupled to the processor 2440, the processor 2440 and memory 2430 configured to perform various functions described herein.

The inter-station communications manager 2445 may manage communications with other base stations 105, and may include a controller or scheduler for controlling communications with UEs 115 in cooperation with other base stations 105. For example, the inter-station communications manager 2445 may coordinate scheduling for transmissions to UEs 115 for various interference mitigation techniques such as beamforming or joint transmission. In some examples, the inter-station communications manager 2445 may provide an X2 interface within an LTE/LTE-A wireless communications network technology to provide communication between base stations 105.

The communications manager 2420 may support wireless communication at the device 2405 (e.g., a base station) in accordance with examples as disclosed herein. For example, the communications manager 2420 may be configured as or otherwise support a means for receiving, from a UE, signaling indicating UE capability information. The communications manager 2420 may be configured as or otherwise support a means for transmitting, to the UE, control signaling indicating a measurement gap sequence configuration based on the UE capability information. The communications manager 2420 may be configured as or otherwise support a means for performing a set of reference signal transmissions for a set of channel measurements during a measurement gap occasion associated with the measurement gap sequence configuration, the measurement gap occasion including one or more of a first measurement gap occasion associated with a first measurement gap sequence, a second measurement gap occasion associated with a second measurement gap sequence, or a combination of the first measurement gap occasion and the second measurement gap occasion. By including or configuring the communications manager 2420 in accordance with examples as described herein, the device 2405 may support techniques for improved communication reliability, reduced latency, and improved coordination between devices.

In some examples, the communications manager 2420 may be configured to perform various operations (e.g., receiving, monitoring, transmitting) using or otherwise in cooperation with the transceiver 2415, the one or more antennas 2425, or any combination thereof. Although the communications manager 2420 is illustrated as a separate component, in some examples, one or more functions described with reference to the communications manager 2420 may be supported by or performed by the processor 2440, the memory 2430, the code 2435, or any combination thereof. For example, the code 2435 may include instructions executable by the processor 2440 to cause the device 2405 to perform various aspects of techniques for performing measurements using multiple measurement gap occasions as described herein, or the processor 2440 and the memory 2430 may be otherwise configured to perform or support such operations.

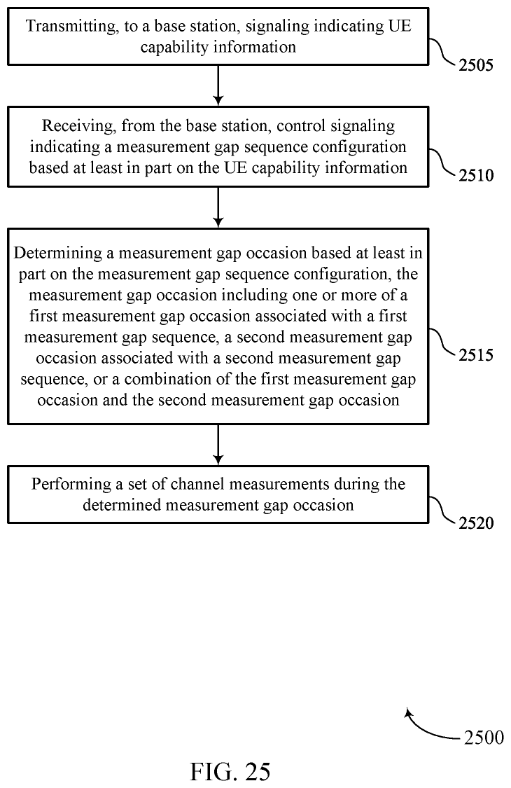

FIG. 25 shows a flowchart illustrating a method 2500 that supports techniques for performing measurements using multiple measurement gap occasions in accordance with various aspects of the present disclosure. The operations of the method 2500 may be implemented by a UE or its components as described herein. For example, the operations of the method 2500 may be performed by a UE 115 as described with reference to FIGS. 1 through 20. In some examples, a UE may execute a set of instructions to control the functional elements of the UE to perform the described functions. Additionally or alternatively, the UE may perform aspects of the described functions using special-purpose hardware.

At 2505, the method may include transmitting, to a base station, signaling indicating UE capability information. The operations of 2505 may be performed in accordance with examples as disclosed herein. In some examples, aspects of the operations of 2505 may be performed by a capability component 1925 as described with reference to FIG. 19.

At 2510, the method may include receiving, from the base station, control signaling indicating a measurement gap sequence configuration based on the UE capability information. The operations of 2510 may be performed in accordance with examples as disclosed herein. In some examples, aspects of the operations of 2510 may be performed by a configuration component 1930 as described with reference to FIG. 19.

At 2515, the method may include determining a measurement gap occasion based on the measurement gap sequence configuration, the measurement gap occasion including one or more of a first measurement gap occasion associated with a first measurement gap sequence, a second measurement gap occasion associated with a second measurement gap sequence, or a combination of the first measurement gap occasion and the second measurement gap occasion. The operations of 2515 may be performed in accordance with examples as disclosed herein. In some examples, aspects of the operations of 2515 may be performed by a measurement gap component 1935 as described with reference to FIG. 19.

At 2520, the method may include performing a set of channel measurements during the determined measurement gap occasion. The operations of 2520 may be performed in accordance with examples as disclosed herein. In some examples, aspects of the operations of 2520 may be performed by a channel component 1940 as described with reference to FIG. 19.

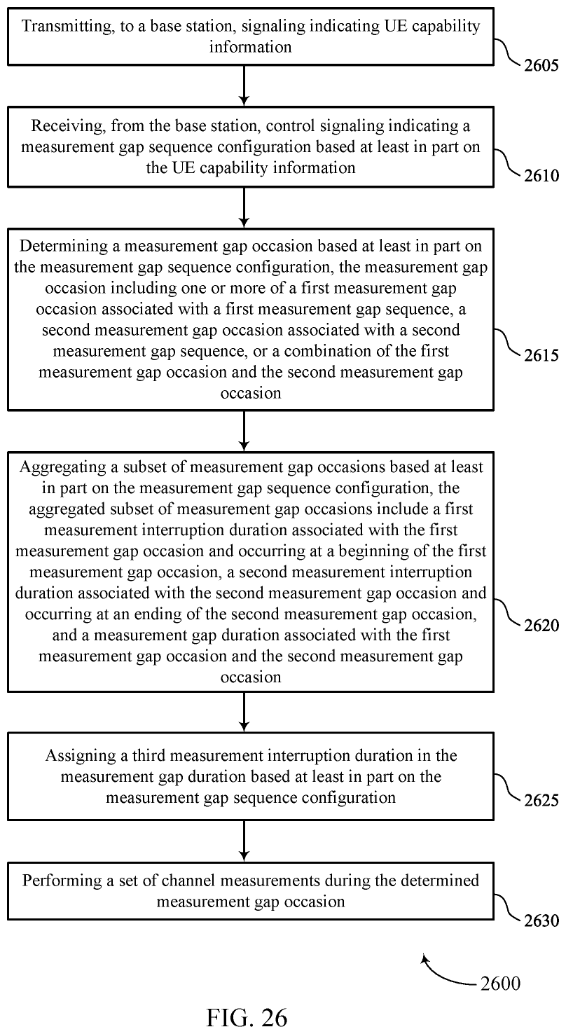

FIG. 26 shows a flowchart illustrating a method 2600 that supports techniques for performing measurements using multiple measurement gap occasions in accordance with various aspects of the present disclosure. The operations of the method 2600 may be implemented by a UE or its components as described herein. For example, the operations of the method 2600 may be performed by a UE 115 as described with reference to FIGS. 1 through 20. In some examples, a UE may execute a set of instructions to control the functional elements of the UE to perform the described functions. Additionally or alternatively, the UE may perform aspects of the described functions using special-purpose hardware.

At 2605, the method may include transmitting, to a base station, signaling indicating UE capability information. The operations of 2605 may be performed in accordance with examples as disclosed herein. In some examples, aspects of the operations of 2605 may be performed by a capability component 1925 as described with reference to FIG. 19.

At 2610, the method may include receiving, from the base station, control signaling indicating a measurement gap sequence configuration based on the UE capability information. The operations of 2610 may be performed in accordance with examples as disclosed herein. In some examples, aspects of the operations of 2610 may be performed by a configuration component 1930 as described with reference to FIG. 19.

At 2615, the method may include determining a measurement gap occasion based on the measurement gap sequence configuration, the measurement gap occasion including one or more of a first measurement gap occasion associated with a first measurement gap sequence, a second measurement gap occasion associated with a second measurement gap sequence, or a combination of the first measurement gap occasion and the second measurement gap occasion. The operations of 2615 may be performed in accordance with examples as disclosed herein. In some examples, aspects of the operations of 2615 may be performed by a measurement gap component 1935 as described with reference to FIG. 19.

At 2620, the method may include aggregating a subset of measurement gap occasions based on the measurement gap sequence configuration, the aggregated subset of measurement gap occasions include a first measurement interruption duration associated with the first measurement gap occasion and occurring at a beginning of the first measurement gap occasion, a second measurement interruption duration associated with the second measurement gap occasion and occurring at an ending of the second measurement gap occasion, and a measurement gap duration associated with the first measurement gap occasion and the second measurement gap occasion. The operations of 2620 may be performed in accordance with examples as disclosed herein. In some examples, aspects of the operations of 2620 may be performed by a measurement gap component 1935 as described with reference to FIG. 19.

At 2625, the method may include assigning a third measurement interruption duration in the measurement gap duration based on the measurement gap sequence configuration. The operations of 2625 may be performed in accordance with examples as disclosed herein. In some examples, aspects of the operations of 2625 may be performed by a timing component 1945 as described with reference to FIG. 19.

At 2630, the method may include performing a set of channel measurements during the determined measurement gap occasion. The operations of 2630 may be performed in accordance with examples as disclosed herein. In some examples, aspects of the operations of 2630 may be performed by a channel component 1940 as described with reference to FIG. 19.

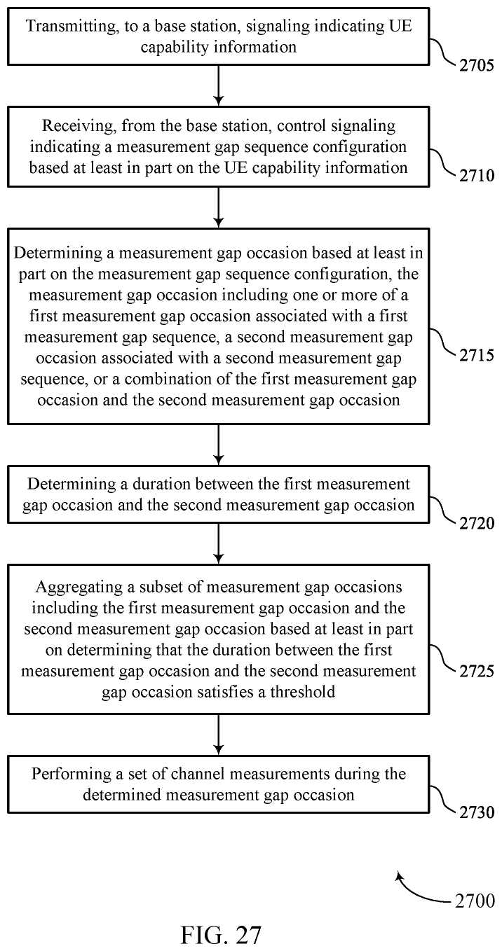

FIG. 27 shows a flowchart illustrating a method 2700 that supports techniques for performing measurements using multiple measurement gap occasions in accordance with various aspects of the present disclosure. The operations of the method 2700 may be implemented by a UE or its components as described herein. For example, the operations of the method 2700 may be performed by a UE 115 as described with reference to FIGS. 1 through 20. In some examples, a UE may execute a set of instructions to control the functional elements of the UE to perform the described functions. Additionally or alternatively, the UE may perform aspects of the described functions using special-purpose hardware.

At 2705, the method may include transmitting, to a base station, signaling indicating UE capability information. The operations of 2705 may be performed in accordance with examples as disclosed herein. In some examples, aspects of the operations of 2705 may be performed by a capability component 1925 as described with reference to FIG. 19.

At 2710, the method may include receiving, from the base station, control signaling indicating a measurement gap sequence configuration based on the UE capability information. The operations of 2710 may be performed in accordance with examples as disclosed herein. In some examples, aspects of the operations of 2710 may be performed by a configuration component 1930 as described with reference to FIG. 19.

At 2715, the method may include determining a measurement gap occasion based on the measurement gap sequence configuration, the measurement gap occasion including one or more of a first measurement gap occasion associated with a first measurement gap sequence, a second measurement gap occasion associated with a second measurement gap sequence, or a combination of the first measurement gap occasion and the second measurement gap occasion. The operations of 2715 may be performed in accordance with examples as disclosed herein. In some examples, aspects of the operations of 2715 may be performed by a measurement gap component 1935 as described with reference to FIG. 19.

At 2725, the method may include determining a duration between the first measurement gap occasion and the second measurement gap occasion. The operations of 2725 may be performed in accordance with examples as disclosed herein. In some examples, aspects of the operations of 2725 may be performed by a timing component 1945 as described with reference to FIG. 19.

At 2730, the method may include aggregating a subset of measurement gap occasions including the first measurement gap occasion and the second measurement gap occasion based on determining that the duration between the first measurement gap occasion and the second measurement gap occasion satisfies a threshold. The operations of 2730 may be performed in accordance with examples as disclosed herein. In some examples, aspects of the operations of 2730 may be performed by a measurement gap component 1935 as described with reference to FIG. 19.

At 2730, the method may include performing a set of channel measurements during the determined measurement gap occasion. The operations of 2730 may be performed in accordance with examples as disclosed herein. In some examples, aspects of the operations of 2730 may be performed by a channel component 1940 as described with reference to FIG. 19.

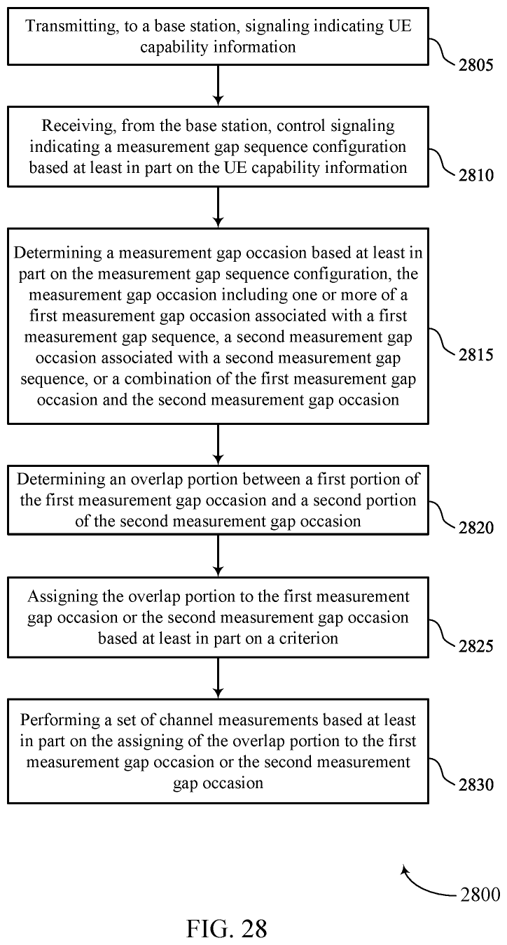

FIG. 28 shows a flowchart illustrating a method 2800 that supports techniques for performing measurements using multiple measurement gap occasions in accordance with various aspects of the present disclosure. The operations of the method 2800 may be implemented by a UE or its components as described herein. For example, the operations of the method 2800 may be performed by a UE 115 as described with reference to FIGS. 1 through 20. In some examples, a UE may execute a set of instructions to control the functional elements of the UE to perform the described functions. Additionally or alternatively, the UE may perform aspects of the described functions using special-purpose hardware.

At 2805, the method may include transmitting, to a base station, signaling indicating UE capability information. The operations of 2805 may be performed in accordance with examples as disclosed herein. In some examples, aspects of the operations of 2805 may be performed by a capability component 1925 as described with reference to FIG. 19.

At 2810, the method may include receiving, from the base station, control signaling indicating a measurement gap sequence configuration based on the UE capability information. The operations of 2810 may be performed in accordance with examples as disclosed herein. In some examples, aspects of the operations of 2810 may be performed by a configuration component 1930 as described with reference to FIG. 19.

At 2815, the method may include determining a measurement gap occasion based on the measurement gap sequence configuration, the measurement gap occasion including one or more of a first measurement gap occasion associated with a first measurement gap sequence, a second measurement gap occasion associated with a second measurement gap sequence, or a combination of the first measurement gap occasion and the second measurement gap occasion. The operations of 2815 may be performed in accordance with examples as disclosed herein. In some examples, aspects of the operations of 2815 may be performed by a measurement gap component 1935 as described with reference to FIG. 19.

At 2820, the method may include determining an overlap portion between a first portion of the first measurement gap occasion and a second portion of the second measurement gap occasion. The operations of 2820 may be performed in accordance with examples as disclosed herein. In some examples, aspects of the operations of 2820 may be performed by an overlap component 1950 as described with reference to FIG. 19.

At 2825, the method may include assigning the overlap portion to the first measurement gap occasion or the second measurement gap occasion based on a criterion. The operations of 2825 may be performed in accordance with examples as disclosed herein. In some examples, aspects of the operations of 2825 may be performed by an overlap component 1950 as described with reference to FIG. 19.

At 2830, the method may include performing a set of channel measurements based on the assigning of the overlap portion to the first measurement gap occasion or the second measurement gap occasion. The operations of 2830 may be performed in accordance with examples as disclosed herein. In some examples, aspects of the operations of 2830 may be performed by a channel component 1940 as described with reference to FIG. 19.

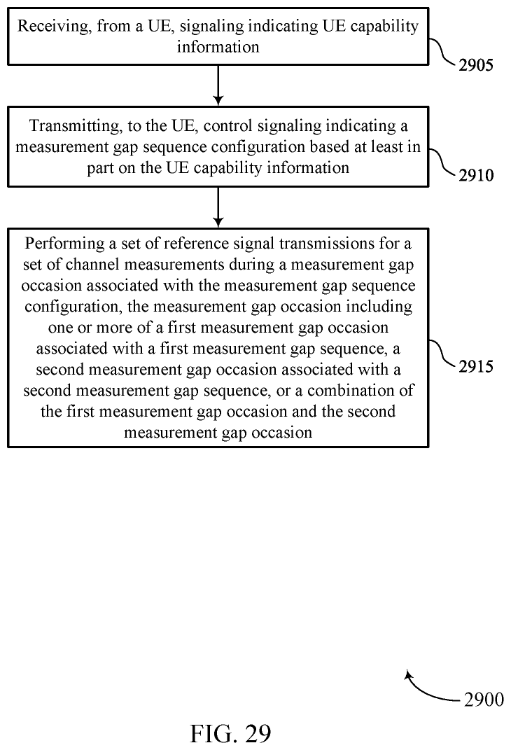

FIG. 29 shows a flowchart illustrating a method 2900 that supports techniques for performing measurements using multiple measurement gap occasions in accordance with various aspects of the present disclosure. The operations of the method 2900 may be implemented by a base station or its components as described herein. For example, the operations of the method 2900 may be performed by a base station 105 as described with reference to FIGS. 1 through 16 and 21 through 24. In some examples, a base station may execute a set of instructions to control the functional elements of the base station to perform the described functions. Additionally or alternatively, the base station may perform aspects of the described functions using special-purpose hardware.

At 2905, the method may include receiving, from a UE, signaling indicating UE capability information. The operations of 2905 may be performed in accordance with examples as disclosed herein. In some examples, aspects of the operations of 2905 may be performed by a capability component 2325 as described with reference to FIG. 23.

At 2910, the method may include transmitting, to the UE, control signaling indicating a measurement gap sequence configuration based on the UE capability information. The operations of 2910 may be performed in accordance with examples as disclosed herein. In some examples, aspects of the operations of 2910 may be performed by a configuration component 2330 as described with reference to FIG. 23.

At 2915, the method may include performing a set of reference signal transmissions for a set of channel measurements during a measurement gap occasion associated with the measurement gap sequence configuration, the measurement gap occasion including one or more of a first measurement gap occasion associated with a first measurement gap sequence, a second measurement gap occasion associated with a second measurement gap sequence, or a combination of the first measurement gap occasion and the second measurement gap occasion. The operations of 2915 may be performed in accordance with examples as disclosed herein. In some examples, aspects of the operations of 2915 may be performed by a channel component 2335 as described with reference to FIG. 23.

The following provides an overview of aspects of the present disclosure:
Aspect 1: A method for wireless communication at a UE, comprising: transmitting, to a base station, signaling indicating UE capability information; receiving, from the base station, control signaling indicating a measurement gap sequence configuration based at least in part on the UE capability information; determining a measurement gap occasion based at least in part on the measurement gap sequence configuration, the measurement gap occasion including one or more of a first measurement gap occasion associated with a first measurement gap sequence, a second measurement gap occasion associated with a second measurement gap sequence, or a combination of the first measurement gap occasion and the second measurement gap occasion; and performing a set of channel measurements during the determined measurement gap occasion.
Aspect 2: The method of aspect 1, further comprising: aggregating a subset of measurement gap occasions based at least in part on the measurement gap sequence configuration, wherein the aggregated subset of measurement gap occasions includes a first measurement interruption duration associated with the first measurement gap occasion and occurring at a beginning of the first measurement gap occasion, a second measurement interruption duration associated with the second measurement gap occasion and occurring at an ending of the second measurement gap occasion, and a measurement gap duration associated with the first measurement gap occasion and the second measurement gap occasion.
Aspect 3: The method of aspect 2, wherein the measurement gap duration is a combined measurement gap duration including a first measurement gap duration associated with the first measurement gap occasion and a second measurement gap duration associated with the second measurement gap occasion.
Aspect 4: The method of any of aspects 2 through 3, further comprising: assigning a third measurement interruption duration in the measurement gap duration based at least in part on the measurement gap sequence configuration, the measurement gap duration is a combined measurement gap duration including a first measurement gap duration associated with the first measurement gap occasion and a second measurement gap duration associated with the second measurement gap occasion, wherein the aggregated subset of measurement gap occasions includes the first measurement interruption duration, the second measurement interruption duration, and the third measurement interruption duration.
Aspect 5: The method of aspect 4, further comprising: determining a temporal location for the third measurement interruption duration in the measurement gap duration based at least in part on one or more of the first measurement interruption duration, the second measurement interruption duration, or the third measurement interruption duration satisfying a threshold.
Aspect 6: The method of any of aspects 1 through 5, wherein the first measurement gap occasion and the second measurement gap occasion are one or more of contiguous or overlapping in a time domain.
Aspect 7: The method of any of aspects 1 through 6, wherein the first measurement gap occasion and the second measurement gap occasion are one or more of noncontiguous or nonoverlapping in a time domain.
Aspect 8: The method of any of aspects 1 through 7, further comprising: determining a duration between the first measurement gap occasion and the second measurement gap occasion; and aggregating a subset of measurement gap occasions including the first measurement gap occasion and the second measurement gap occasion based at least in part on determining that the duration between the first measurement gap occasion and the second measurement gap occasion satisfies a threshold, wherein performing the set of channel measurements is during the aggregated subset of measurement gap occasions.
Aspect 9: The method of aspect 8, wherein a measurement gap duration associated with the aggregated subset of measurement gap occasions includes a first measurement gap duration associated with the first measurement gap occasion, a second measurement gap duration associated with the second measurement gap occasion, and the duration between the first measurement gap occasion and the second measurement gap occasion.
Aspect 10: The method of any of aspects 8 through 9, further comprising: ignoring the first measurement gap occasion or the second measurement gap occasion based at least in part on one or more of a criterion or that the duration between the first measurement gap occasion and the second measurement gap occasion satisfies the threshold.
Aspect 11: The method of aspect 10, wherein the criterion includes one or more of the first measurement gap occasion beginning before or after the second measurement gap occasion, a first measurement duration associated with the first measurement gap occasion is greater or less than a second measurement duration associated with the second measurement gap occasion, a first priority associated with the first measurement gap occasion is higher or lower than a second priority associated with the second measurement gap occasion, or a first reference signal measurement associated with the first measurement gap occasion and a second reference signal measurement associated with the second measurement gap occasion.
Aspect 12: The method of any of aspects 10 through 11, wherein the criterion includes one or more of an RRC configuration, an active BWP, or the UE capability information.
Aspect 13: The method of any of aspects 1 through 12, further comprising: determining an overlap portion between a first portion of the first measurement gap occasion and a second portion of the second measurement gap occasion, wherein performing the set of channel measurements is based at least in part on the determining of the overlap portion between the first portion of the first measurement gap occasion and the second portion of the second measurement gap occasion.
Aspect 14: The method of aspect 13, further comprising: assigning the overlap portion to the first measurement gap occasion or the second measurement gap occasion based at least in part on a criterion, wherein performing the set of channel measurements is based at least in part on the assigning of the overlap portion to the first measurement gap occasion or the second measurement gap occasion.
Aspect 15: The method of aspect 14, wherein the criterion includes one or more of the first measurement gap occasion beginning before or after the second measurement gap occasion, a first measurement duration associated with the first measurement gap occasion is greater or less than a second measurement duration associated with the second measurement gap occasion, a first priority associated with the first measurement gap occasion is higher or lower than a second priority associated with the second measurement gap occasion, or a first reference signal measurement associated with the first measurement gap occasion and a second reference signal measurement associated with the second measurement gap occasion.
Aspect 16: The method of any of aspects 14 through 15, wherein the criterion includes one or more of an RRC configuration, an active BWP, or the UE capability information.
Aspect 17: The method of any of aspects 13 through 16, further comprising: ignoring the first measurement gap occasion or the second measurement gap occasion based at least in part on the determining of the overlap portion between the first portion of the first measurement gap occasion and the second portion of the second measurement gap occasion.
Aspect 18: The method of any of aspects 13 through 17, further comprising: aggregating a subset of measurement gap occasions including the first measurement gap occasion and the second measurement gap occasion based at least in part on the determining of the overlap portion between the first portion of the first measurement gap occasion and the second portion of the second measurement gap occasion, wherein performing the set of channel measurements is in accordance with the aggregated subset of measurement gap occasions.
Aspect 19: The method of aspect 18, wherein a measurement gap duration of the aggregated subset of measurement gap occasions is based at least in part on a first measurement gap duration associated with the first measurement gap occasion, a second measurement gap duration associated with the second measurement gap occasion, and the overlap portion between the first portion of the first measurement gap occasion and the second portion of the second measurement gap occasion, the measurement gap duration including one or more of a first measurement interruption duration associated with the first measurement gap occasion, a second measurement interruption duration associated with the second measurement gap occasion, or a third measurement interruption duration associated with the aggregated subset of measurement gap occasions.
Aspect 20: The method of any of aspects 1 through 19, wherein the control signaling includes radio resource control signaling and the measurement gap sequence configuration indicates one or more of a beginning of the measurement gap occasion or a number of measurement gap occasions associated with a measurement gap sequence including the measurement gap occasion.
Aspect 21: A method for wireless communication at a base station, comprising: receiving, from a UE, signaling indicating UE capability information; transmitting, to the UE, control signaling indicating a measurement gap sequence configuration based at least in part on the UE capability information; and performing a set of reference signal transmissions for a set of channel measurements during a measurement gap occasion associated with the measurement gap sequence configuration, the measurement gap occasion including one or more of a first measurement gap occasion associated with a first measurement gap sequence, a second measurement gap occasion associated with a second measurement gap sequence, or a combination of the first measurement gap occasion and the second measurement gap occasion.
Aspect 22: The method of aspect 21, wherein the measurement gap occasion includes an aggregated subset of measurement gap occasions including a first measurement interruption duration associated with the first measurement gap occasion, a second measurement interruption duration associated with the second measurement gap occasion, and a measurement gap duration associated with the first measurement gap occasion and the second measurement gap occasion.
Aspect 23: The method of aspect 22, wherein the measurement gap duration includes a first measurement gap duration associated with the first measurement gap occasion and a second measurement gap duration associated with the second measurement gap occasion.
Aspect 24: The method of any of aspects 22 through 23, wherein the aggregated subset of measurement gap occasions includes the first measurement interruption duration, the second measurement interruption duration, and a third measurement interruption duration.
Aspect 25: The method of any of aspects 21 through 24, wherein the first measurement gap occasion and the second measurement gap occasion are one or more of contiguous or overlapping in a time domain.
Aspect 26: The method of any of aspects 21 through 25, wherein the first measurement gap occasion and the second measurement gap occasion are noncontiguous or nonoverlapping in a time domain.
Aspect 27: The method of any of aspects 21 through 26, wherein the control signaling includes radio resource control signaling and the measurement gap sequence configuration indicates one or more of a beginning of the measurement gap occasion or a number of measurement gap occasions associated with a measurement gap sequence including the measurement gap occasion.
Aspect 28: The method of any of aspects 21 through 27, wherein the measurement gap duration includes a first measurement gap duration associated with the first measurement gap occasion, a second measurement gap duration associated with the second measurement gap occasion, and a duration between the first measurement gap occasion and the second measurement gap occasion.
Aspect 29: An apparatus for wireless communication at a UE, comprising a processor; memory coupled with the processor; and instructions stored in the memory and executable by the processor to cause the apparatus to perform a method of any of aspects 1 through 20.
Aspect 30: An apparatus for wireless communication at a UE, comprising at least one means for performing a method of any of aspects 1 through 20.
Aspect 31: A non-transitory computer-readable medium storing code for wireless communication at a UE, the code comprising instructions executable by a processor to perform a method of any of aspects 1 through 20.
Aspect 32: An apparatus for wireless communication at a base station, comprising a processor; memory coupled with the processor; and instructions stored in the memory and executable by the processor to cause the apparatus to perform a method of any of aspects 21 through 28.
Aspect 33: An apparatus for wireless communication at a base station, comprising at least one means for performing a method of any of aspects 21 through 28.
Aspect 34: A non-transitory computer-readable medium storing code for wireless communication at a base station, the code comprising instructions executable by a processor to perform a method of any of aspects 21 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the present disclosure may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the present disclosure. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
transmitting, to a base station, signaling indicating UE capability information;
receiving, from the base station, control signaling indicating a measurement gap sequence configuration based at least in part on the UE capability information;
determining a measurement gap occasion based at least in part on the measurement gap sequence configuration, the measurement gap occasion including one or more of a first measurement gap occasion associated with a first measurement gap sequence, a second measurement gap occasion associated with a second measurement gap sequence, or a combination of the first measurement gap occasion and the second measurement gap occasion; and
performing a set of channel measurements during the determined measurement gap occasion.

2. The method of claim 1, further comprising:
aggregating a subset of measurement gap occasions based at least in part on the measurement gap sequence configuration,
wherein the aggregated subset of measurement gap occasions includes a first measurement interruption duration associated with the first measurement gap occasion and occurring at a beginning of the first measurement gap occasion, a second measurement interruption duration associated with the second measurement gap occasion and occurring at an ending of the second measurement gap occasion, and a measurement gap duration associated with the first measurement gap occasion and the second measurement gap occasion.

3. The method of claim 2, wherein the measurement gap duration is a combined measurement gap duration including a first measurement gap duration associated with the first measurement gap occasion and a second measurement gap duration associated with the second measurement gap occasion.

4. The method of claim 2, further comprising:
assigning a third measurement interruption duration in the measurement gap duration based at least in part on the measurement gap sequence configuration, the measurement gap duration is a combined measurement gap duration including a first measurement gap duration associated with the first measurement gap occasion and a second measurement gap duration associated with the second measurement gap occasion,
wherein the aggregated subset of measurement gap occasions includes the first measurement interruption duration, the second measurement interruption duration, and the third measurement interruption duration.

5. The method of claim 4, further comprising:
determining a temporal location for the third measurement interruption duration in the measurement gap duration based at least in part on one or more of the first measurement interruption duration, the second measurement interruption duration, or the third measurement interruption duration satisfying a threshold.

6. The method of claim 1, wherein the first measurement gap occasion and the second measurement gap occasion are one or more of contiguous or overlapping in a time domain.

7. The method of claim 1, wherein the first measurement gap occasion and the second measurement gap occasion are one or more of noncontiguous or nonoverlapping in a time domain.

8. The method of claim 1, further comprising:
determining a duration between the first measurement gap occasion and the second measurement gap occasion; and
aggregating a subset of measurement gap occasions including the first measurement gap occasion and the second measurement gap occasion based at least in part on determining that the duration between the first measurement gap occasion and the second measurement gap occasion satisfies a threshold,
wherein performing the set of channel measurements is during the aggregated subset of measurement gap occasions.

9. The method of claim 8, wherein a measurement gap duration associated with the aggregated subset of measurement gap occasions includes a first measurement gap duration associated with the first measurement gap occasion, a second measurement gap duration associated with the second measurement gap occasion, and the duration between the first measurement gap occasion and the second measurement gap occasion.

10. The method of claim 8, further comprising:
ignoring the first measurement gap occasion or the second measurement gap occasion based at least in part on one or more of a criterion or that the duration between the first measurement gap occasion and the second measurement gap occasion satisfies the threshold.

11. The method of claim 10, wherein the criterion includes one or more of the first measurement gap occasion beginning before or after the second measurement gap occasion, a first measurement duration associated with the first measurement gap occasion is greater or less than a second measurement duration associated with the second measurement gap occasion, a first priority associated with the first measurement gap occasion is higher or lower than a second priority associated with the second measurement gap occasion, or a first reference signal measurement associated with the first measurement gap occasion and a second reference signal measurement associated with the second measurement gap occasion.

12. The method of claim 10, wherein the criterion includes one or more of a radio resource control configuration, an active bandwidth part, or the UE capability information.

13. The method of claim 1, further comprising:
determining an overlap portion between a first portion of the first measurement gap occasion and a second portion of the second measurement gap occasion,
wherein performing the set of channel measurements is based at least in part on the determining of the overlap portion between the first portion of the first measurement gap occasion and the second portion of the second measurement gap occasion.

14. The method of claim 13, further comprising:
assigning the overlap portion to the first measurement gap occasion or the second measurement gap occasion based at least in part on a criterion,
wherein performing the set of channel measurements is based at least in part on the assigning of the overlap portion to the first measurement gap occasion or the second measurement gap occasion.

15. The method of claim 14, wherein the criterion includes one or more of the first measurement gap occasion beginning before or after the second measurement gap occasion, a first measurement duration associated with the first measurement gap occasion is greater or less than a second measurement duration associated with the second measurement gap occasion, a first priority associated with the first measurement gap occasion is higher or lower than a second priority associated with the second measurement gap occasion, or a first reference signal measurement associated with the first measurement gap occasion and a second reference signal measurement associated with the second measurement gap occasion.

16. The method of claim 14, wherein the criterion includes one or more of a radio resource control configuration, an active bandwidth part, or the UE capability information.

17. The method of claim 13, further comprising:
ignoring the first measurement gap occasion or the second measurement gap occasion based at least in part on the determining of the overlap portion between the first portion of the first measurement gap occasion and the second portion of the second measurement gap occasion.

18. The method of claim 13, further comprising:
aggregating a subset of measurement gap occasions including the first measurement gap occasion and the second measurement gap occasion based at least in part on the determining of the overlap portion between the first portion of the first measurement gap occasion and the second portion of the second measurement gap occasion,
wherein performing the set of channel measurements is during the aggregated subset of measurement gap occasions.

19. The method of claim 18, wherein a measurement gap duration of the aggregated subset of measurement gap occasions is based at least in part on a first measurement gap duration associated with the first measurement gap occasion, a second measurement gap duration associated with the second measurement gap occasion, and the overlap portion between the first portion of the first measurement gap occasion and the second portion of the second measurement gap occasion, the measurement gap duration including one or more of a first measurement interruption duration associated with the first measurement gap occasion, a second measurement interruption duration associated with the second measurement gap occasion, or a third measurement interruption duration associated with the aggregated subset of measurement gap occasions.

20. The method of claim 1, wherein the control signaling includes radio resource control signaling and the measurement gap sequence configuration indicates one or more of a beginning of the measurement gap occasion or a number of measurement gap occasions associated with a measurement gap sequence including the measurement gap occasion.

21. A method for wireless communication at a base station, comprising:
receiving, from a user equipment (UE), signaling indicating UE capability information;
transmitting, to the UE, control signaling indicating a measurement gap sequence configuration based at least in part on the UE capability information; and
performing a set of reference signal transmissions for a set of channel measurements during a measurement gap occasion associated with the measurement gap sequence configuration, the measurement gap occasion including one or more of a first measurement gap occasion associated with a first measurement gap sequence, a second measurement gap occasion associated with a second measurement gap sequence, or a combination of the first measurement gap occasion and the second measurement gap occasion.

22. The method of claim 21, wherein the measurement gap occasion includes an aggregated subset of measurement gap occasions including a first measurement interruption duration associated with the first measurement gap occasion, a second measurement interruption duration associated with the second measurement gap occasion, and a measurement gap duration associated with the first measurement gap occasion and the second measurement gap occasion.

23. The method of claim 22, wherein the measurement gap duration includes a first measurement gap duration associated with the first measurement gap occasion and a second measurement gap duration associated with the second measurement gap occasion.

24. The method of claim 22, wherein the aggregated subset of measurement gap occasions includes the first measurement interruption duration, the second measurement interruption duration, and a third measurement interruption duration.

25. The method of claim 21, wherein the first measurement gap occasion and the second measurement gap occasion are one or more of contiguous or overlapping in a time domain.

26. The method of claim 21, wherein the first measurement gap occasion and the second measurement gap occasion are noncontiguous or nonoverlapping in a time domain.

27. The method of claim 21, wherein the control signaling includes radio resource control signaling and the measurement gap sequence configuration indicates one or more of a beginning of the measurement gap occasion or a number of measurement gap occasions associated with a measurement gap sequence including the measurement gap occasion.

28. The method of claim 21, wherein the measurement gap duration includes a first measurement gap duration associated with the first measurement gap occasion, a second measurement gap duration associated with the second measurement gap occasion, and a duration between the first measurement gap occasion and the second measurement gap occasion.

29. An apparatus for wireless communication at a user equipment (UE), comprising:
a processor;
memory coupled with the processor; and
instructions stored in the memory and executable by the processor to cause the apparatus to:
transmit, to a base station, signaling indicating UE capability information;
receive, from the base station, control signaling indicating a measurement gap sequence configuration based at least in part on the UE capability information;
determine a measurement gap occasion based at least in part on the measurement gap sequence configuration, the measurement gap occasion including one or more of a first measurement gap occasion associated with a first measurement gap sequence, a second measurement gap occasion associated with a second measurement gap sequence, or a combination of the first measurement gap occasion and the second measurement gap occasion; and
perform a set of channel measurements during the determined measurement gap occasion.

30. An apparatus for wireless communication at a base station, comprising:
a processor;
memory coupled with the processor; and
instructions stored in the memory and executable by the processor to cause the apparatus to:
receive, from a user equipment (UE), signaling indicating UE capability information;
transmit, to the UE, control signaling indicating a measurement gap sequence configuration based at least in part on the UE capability information; and
perform a set of reference signal transmissions for a set of channel measurements during a measurement gap occasion associated with the measurement gap sequence configuration, the measurement gap occasion including one or more of a first measurement gap occasion associated with a first measurement gap sequence, a second measurement gap occasion associated with a second measurement gap sequence, or a combination of the first measurement gap occasion and the second measurement gap occasion.
